(19) United States
(12) Patent Application Publication
(10) Pub. No.: US 2025/0110802 A1
(43) Pub. Date: Apr. 3, 2025

(54) RESOURCE ALLOCATION APPARATUS AND RESOURCE ALLOCATION METHOD

(71) Applicants: Fujitsu Limited, Kawasaki-shi (JP); NIPPON TELEGRAPH AND TELEPHONE CORPORATION, Tokyo (JP)

(72) Inventors: Masataka SONODA, Kawasaki (JP); Kazuhiro SUZUKI, Kawasaki (JP); Teruaki ISHIZAKI, Tokyo-to Musashino-shi (JP); Sampath PRIYANKARA, Tokyo-to Musashino-shi (JP); Yoshiro YAMABE, Tokyo-to Musashino-shi (JP); Yuki ARIKAWA, Tokyo-to Musashino-shi (JP); Naoki MIURA, Tokyo-to Musashino-shi (JP)

(73) Assignees: Fujitsu Limited, Kawasaki-shi (JP); NIPPON TELEGRAPH AND TELEPHONE CORPORATION, Tokyo (JP)

(21) Appl. No.: 18/892,879

(22) Filed: Sep. 23, 2024

(30) Foreign Application Priority Data
Sep. 29, 2023 (JP) 2023-170484

(51) Int. Cl. G06F 9/50

(52) U.S. Cl. CPC G06F 9/5083

(57) ABSTRACT

A resource allocation apparatus selects, based on process information indicating a plurality of functions to be used in performing a process and performance requirements for communications between the plurality of functions, the plurality of functions one by one as a first function in order of the performance requirements, the process being performed by a computing system including a plurality of devices, each of the plurality of devices being bus-connected to one or more other devices. The resource allocation apparatus then determines a first device that is used to implement the first function, based on distances of bus-based communication paths between each of devices that are able to implement the first function and a second device that is used to implement a second function that is a communication partner of the first function.

### CROSS-REFERENCE TO RELATED APPLICATION

This application is based upon and claims the benefit of priority of the prior Japanese Patent Application No. 2023-170484, filed on Sep. 29, 2023, the entire contents of which are incorporated herein by reference.

### FIELD

The embodiments discussed herein relate to a resource allocation apparatus and a resource allocation method.

### BACKGROUND

In a computing system (hereinafter, referred to as a “system,” simply), it is difficult to estimate which types of resources in the system will be used, and when and to what extent they will be used, due to the diversification and irregular load pattern of application software that runs on the system. Inaccurate resource usage estimates tend to result in low resource usage efficiency. On the other hand, there is a growing demand for low-energy, high-efficiency systems.

One approach to address the above background is a technique called disaggregation. Unlike enclosure (server)-centric resource extraction (virtual machines (VMs), containers, and others), the disaggregation separates resources in units of compute elements (such as central processing units (CPUs)) and devices (such as accelerators). The disaggregation also combines resources according to requirements to build a virtual computer.

For example, the requirements are specified in a data flow (DF). For example, the DF defines functions to be used to implement a service. Computers built using the disaggregation are called logical service nodes (LSNs). The disaggregation technique is expected to improve the of resources and accordingly reduce power utilization consumption.

As a technique related to system building, for example, a computer system has been proposed, which is able to arrange a virtual computer and a volume in a cluster without degrading the input/output performance of the virtual computer. Further, a moving target container determination method has been proposed, which suppresses an increase in communication delay time due to the movement of a container. Still further, there has been proposed a disaggregated compute system.

Japanese Laid-open Patent Publication NO. 2021-149299

Japanese Laid-open Patent Publication NO. 2021-150876

Japanese National Publication of International Patent Application NO. 2019-511051

### SUMMARY

According to one aspect, there is provided a resource allocation apparatus including: a memory; and a processor coupled to the memory and the processor configured to: first select, based on process information indicating a plurality of functions to be used in performing a process and performance requirements for communications between the plurality of functions, the plurality of functions one by one as a first function in order of the performance requirements, the process being performed by a computing system including a plurality of devices, each of the plurality of devices being bus-connected to one or more others of the plurality of devices; and determine a first device that is used to implement the first function, based on distances of bus-based communication paths between each of devices that are able to implement the first function and a second device that is used to implement a second function that is a communication partner of the first function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a resource allocation method according to a first embodiment;

FIG. 2 illustrates an example of a system configuration according to a second embodiment;

FIG. 3 illustrates an example of hardware of a management computer;

FIG. 4 illustrates an example of hardware configuration of an infrastructure system;

FIG. 5 illustrates an example of a server that runs on a logical service node (LSN);

FIG. 6 illustrates examples of inter-device communication;

FIG. 7 illustrates examples of inter-device communication using Ethernet;

FIG. 8 illustrates examples of communication between devices in different servers;

FIG. 9 illustrates an example of how the configurations of LSNs are managed;

FIG. 10 illustrates an example of device allocation to functions;

FIG. 11 illustrates an example of an increase in communication latency due to a long communication path;

FIG. 12 illustrates an example of an increase in communication latency due to the communication of another server;

FIG. 13 is a block diagram illustrating an example of functions of the management computer;

FIG. 14 illustrates an example of physical configuration information;

FIG. 15 illustrates an example of device information;

FIG. 16 illustrates an example of network status information;

FIG. 17 illustrates an example of LSN configuration information;

FIG. 18 illustrates an example of device allocation information;

FIG. 19 illustrates an example of path information;

FIG. 20 illustrates an example of server configuration information;

FIG. 21 illustrates an example of input and output data to and from a resource deployment scheduler;

FIG. 22 illustrates flows of data in the management computer;

FIG. 23 is a flowchart illustrating an example procedure for a resource deployment process performed by the resource deployment scheduler;

FIG. 24 illustrates an example of device selection;

FIG. 25 illustrates an example of device selection completed at a first stage;

FIG. 26 illustrates an example of device selection completed at a second stage;

FIG. 27 illustrates an example of device selection completed at a third stage;

FIG. 28 is a first flowchart illustrating an example procedure for a device selection process;

FIG. 29 is a second flowchart illustrating the example procedure for the device selection process;

FIG. 30 is a third flowchart illustrating the example procedure for the device selection process;

FIG. 31 is a fourth flowchart illustrating the example procedure for the device selection process;

FIG. 32 illustrates an example of path selection;

FIG. 33 is a flowchart illustrating an example procedure for a path selection process;

FIG. 34 illustrates an example of server design;

FIG. 35 is a flowchart illustrating an example procedure for a server design process;

FIG. 36 is a first diagram illustrating a first example of resource deployment;

FIG. 37 is a second diagram illustrating the first example of the resource deployment;

FIG. 38 is a third diagram illustrating the first example of the resource deployment;

FIG. 39 is a fourth diagram illustrating the first example of the resource deployment;

FIG. 40 is a first diagram illustrating a second example of the resource deployment;

FIG. 41 is a second diagram illustrating the second example of the resource deployment;

FIG. 42 is a third diagram illustrating the second example of the resource deployment;

FIG. 43 is a fourth diagram illustrating the second example of the resource deployment;

FIG. 44 is a fifth diagram illustrating the second example of the resource deployment;

FIG. 45 is a sixth diagram illustrating the second example of the resource deployment; and

FIG. 46 is a seventh diagram illustrating the second example of the resource deployment.

### DESCRIPTION OF EMBODIMENTS

In deploying a new logical service node (LSN) within a system according to a data flow (DF) defining functions, simply allocating available devices to the functions may significantly impair the DF execution performance. For example, devices that are physically distant from each other (for example, with many intervening switches) may be allocated to two communicating functions. In this case, the communication between the devices suffers from high latency, which ends up increasing the processing delay of a service running on the LSN and thus hindering smooth execution of the DF. In addition, in the case where there are a plurality of DFs to be executed and devices that are far apart from each other are allocated to the functions of each DF, communication paths are likely to overlap, and an increase in communication traffic during the execution of one DF hinders smooth execution of another DF.

Embodiments will now be described with reference to the drawings. Note that features of some embodiments may be combined unless they exclude each other.

### First Embodiment

A first embodiment relates to a resource allocation method that is able to allocate resources to servers that perform processes using a plurality of functions, without degrading the performance of the processes.

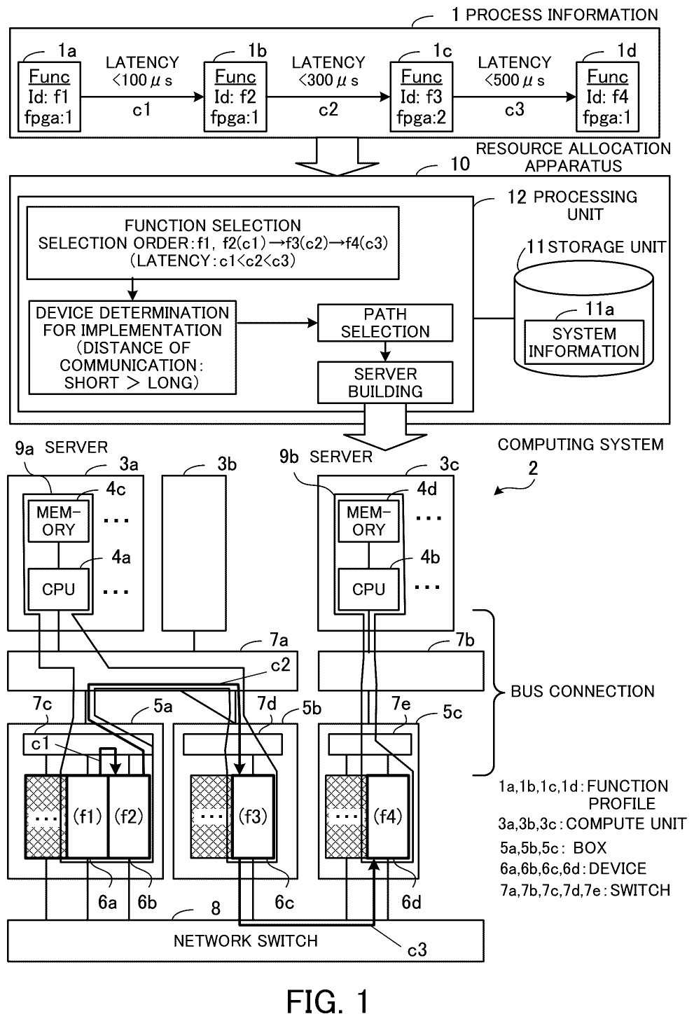

FIG. 1 illustrates an example of a resource allocation method according to the first embodiment. FIG. 1 illustrates a resource allocation apparatus 10 that performs the resource allocation method. For example, the resource allocation apparatus 10 runs a resource allocation program to perform the resource allocation method.

The resource allocation apparatus 10 allocates resources provided in a computing system 2 to servers 9a and 9b that are used to perform the processes indicated in process information 1. The resources to be allocated include CPUs, memories, and a plurality of devices such as accelerators. The CPUs and memories are included in compute units 3a, 3b, and 3c. For example, the compute unit 3a includes a CPU 4a and a memory 4c. The compute unit 3c includes a CPU 4b and a memory 4d. The devices are contained in device-mounting BOXes 5a, 5b, and 5c. For examples, the BOX 5a contains devices 6a and 6b. The BOX 5b contains a device 6c. The BOX 5c contains a device 6d.

The resources are bus-connected via bus switches 7a to 7e. For example, the CPU 4a in the compute unit 3a is connected to the switch 7a, which is further connected to the switch 7c in the BOX 5a and the switch 7d in the BOX 5b. The devices 6a and 6b in the BOX 5a are connected to the switch 7c. The device 6c in the BOX 5b is connected to the switch 7d. The CPU 4b in the compute unit 3c is connected to the switch 7b, which is further connected to the switch 7e in the BOX 5c. The device 6d in the BOX 5c is connected to the switch 7e. As described above, each of the plurality of devices is bus-connected to at least one of the other devices.

The devices are also connected via network to each other. For example, the devices 6a and 6b in the BOX 5a, the device 6c in the BOX 5b, and the device 6d in the BOX 5c are connected to a network switch 8 so as to communicate with each other via the network switch 8.

The resource allocation apparatus 10 includes a storage unit 11 and a processing unit 12. The storage unit 11 is, for example, a memory or storage device provided in the resource allocation apparatus 10. The processing unit 12 is, for example, a processor or computing circuit provided in the resource allocation apparatus 10.

The resource allocation apparatus 10 performs resource allocation on the basis of the process information 1. The process information 1 indicates a plurality of functions to be executed by the computing system 2 and performance requirements for communications between the plurality of functions. For example, the process information 1 includes function profiles 1a to 1d that respectively define the plurality of functions that are used to perform processes. The term “function” may be abbreviated as “Func” in the drawings.

The resource allocation apparatus 10 determines, for each of the plurality of functions indicated in the process information 1, devices that are used to implement the function.

The storage unit 11 stores system information 11a indicating the hardware configuration and others of the computing system 2. The system information 11a describes the resources included in the computing system 2 and the connections between the resources.

The processing unit 12 obtains the system configuration from the system information 11a, and allocates resources without degrading the processing performance. More specifically, the processing unit 12 performs the resource allocation as follows.

The processing unit 12 selects the plurality of functions one by one in order of the communication performance requirements, with reference to the process information 1. For example, the processing unit 12 selects the functions in order, starting with the function with the highest communication performance requirements.

Assume, for example, that the function defined by the function profile 1a is denoted as “f1,” the function defined by the function profile 1b is denoted as “f2,” the function defined by the function profile 1c is denoted as “f3,” and the function defined by the function profile 1d is denoted as “f4.” The communication between the functions “f1” and “f2” is denoted as “c1.” The communication between the functions “f2” and “f3” is denoted as “c2.” The communication between the functions “f3” and “f4” is denoted as “c3.”

In the example of FIG. 1, the performance requirements for each communication are defined as an allowable latency. The communication “c1” has an allowable latency less than “100 μs,” the communication “c2” has an allowable latency less than “300 μs,” and the communication “c3” has an allowable latency less than “500 μs.” In the case where performance is expressed in terms of allowable latency, means a lower allowable latency higher performance requirements. Therefore, the processing unit 12 selects the functions in order, for example, starting with the function that needs a communication with the lowest allowable latency. In the example of FIG. 1, the selection order of the functions is as follows: the functions “f1” and “f2” are selected first, the function “f3” is selected second, and the function “f4” is selected third.

Then, the processing unit 12 determines a first device that is used to execute the selected function (first function) from among the devices 6a to 6d (available devices that have not been allocated to any functions) that are able to implement the selected first function. For example, the processing unit 12 determines the first device that is used to implement the first function, on the basis of the distances of bus-based communication paths between each of the devices 6a to 6d that are able to implement the first function and a second device that is used to implement a function (second function) that is a communication partner of the first function.

The distance of a bus-based communication path is defined as the number of switches 7a to 7e in the bus-based communication path, for example. In the case where the number of switches in a communication path represents the distance of the communication path, for example, the processing unit 12 sets, as the first device, the device that has the fewest switches 7a to 7e in the bus-based communication path to the second device.

In the case where the devices 6a to 6d that are able to implement the first function do not include any device that is bus-connected to the second device, the processing unit 12 sets, as the first device, a device that is network-connected to the second device.

In this connection, determining a device that is used to implement a function may be rephrased as allocating the device, which is used to implement the function, to the function.

Assume, for example, that each function defined by the function profiles 1a to 1d is executable by at least one of the devices 6a to 6d. In this case, the processing unit 12 first selects the functions “f1” and “f2” and determines devices that are used to execute these functions. In the example of FIG. 1, the bus-based communication path between the devices 6a and 6b in the BOX 5a has the shortest distance. Therefore, for example, the processing unit 12 allocates the device 6a to the function “f1” and the device 6b to the function “f2.”

More specifically, assume that the processing unit 12 selects the functions “f1” and “f2” in this order. When selecting the function “f1” first, for example, the processing unit 12 allocates the device 6a in the BOX 5a that has the highest number of available devices to the function “f1.” Then, the processing unit 12 selects the function “f2,” and allocates the device 6b that has the shortest bus-based communication path to the device 6a, to the function “f2.”

After that, the processing unit 12 selects the function “f3.” The device 6b is already allocated to the function “f2” that communicates with the function “f3.” The devices 6c and 6d are currently available. The device 6c is bus-connected via three switches 7d, 7a, and 7c to the device 6b, which is allocated to the function “f2.” The device 6d is not bus-connected to the device 6b, which is allocated to the function “f2,” but is network-connected thereto via the network switch 8. In this case, the processing unit 12 allocates the bus-connected device 6c to the function “f3.”

Lastly, the processing unit 12 selects the function “f4.” The device 6c is already allocated to the function “f3” that communicates with the function “f4.” There is no available device that is able to perform bus-based communication with the device 6c. Therefore, the processing unit 12 allocates the device 6d, which is network-connected to the device 6c, to the function “f4.”

As described above, the processing unit 12 selects the functions in order, starting with the function with the highest communication performance requirements, and allocates, to the selected function, a device that has a short bus-based communication path to a device allocated to the communication partner function of the selected function. As a result, devices that have a shorter distance therebetween are allocated to the functions at both ends of a communication with higher communication performance requirements, thereby preventing an increase in communication latency. Furthermore, the allocation of devices having a short distance therebetween to the functions at both ends of a communication with high communication performance requirements reduces the risk that the communication path between the devices overlaps with the communication paths between devices that perform other processes. In other words, the communication path for the communication with high communication performance requirements is separated from the communication paths for other processes, which prevents a communication delay caused by the communications between the other processes. As a result, the processes that use the plurality of functions distributed across the plurality of devices are facilitated.

In addition, the processing unit 12 is able to appropriately select whether to use bus-based communication or network-based communication, for each communication between the functions. To this end, for example, for each communication between the functions, the processing unit 12 checks the number of switches in the bus-based communication path connecting the devices that implement the communicating functions, or the performance of the bus-based communication and network-based communication against the performance requirements for the communication. Then, on the basis of the check results, the processing unit 12 selects, for each combination of two communicating functions, either the communication path via bus (first communication path) or the communication path via network (second communication path) as the communication path for their communication. For example, the processing unit 12 selects a communication path that satisfies the performance requirements of a communication as the path for the communication. This prevents each communication between the functions from failing to satisfy the performance requirements.

For example, in the case where the bus-based communication passes through only one switch, the processing unit 12 selects the first communication path via bus as the communication path for the communication. More specifically, devices allocated to two communicating functions in the same BOX are bus-connected to each other via only one switch. Unless the communication path via bus between the communicating functions does not involve any communication between the switch and another switch, this communication path is not affected by congestion on the path connecting these switches and, thus, is not affected by other processes. That is, efficient bus-based communication is achieved.

In the case where both the bus-based communication and the network-based communication satisfy the performance requirements for a communication between a plurality of functions, the processing unit 12 may select the second communication path via network as the communication path for the communication. On the condition that the network-based communication satisfies the performance requirements, the use of the network-based communication contributes to reducing the data traffic in the bus-based communication. As a result, it is possible to reduce the influence of communications performed for processes indicated in the process information 1 on other processes.

Furthermore, in the case where neither the bus-based communication nor the network-based communication satisfies the performance requirements for the communication between the plurality of functions, the processing unit 12 selects the second communication path via network as the communication path for the communication. On the condition that there is little difference in performance between these communication paths, the use of the network-based communication contributes to reducing the traffic in the bus-based communication. As a result, the communications for a plurality of DFs are prevented from overlapping in a bus-based communication path, thereby preventing the occurrence of congestion.

### Second Embodiment

A second embodiment relates to a system in which a server that analyzes data collected over a network is built in an infrastructure system.

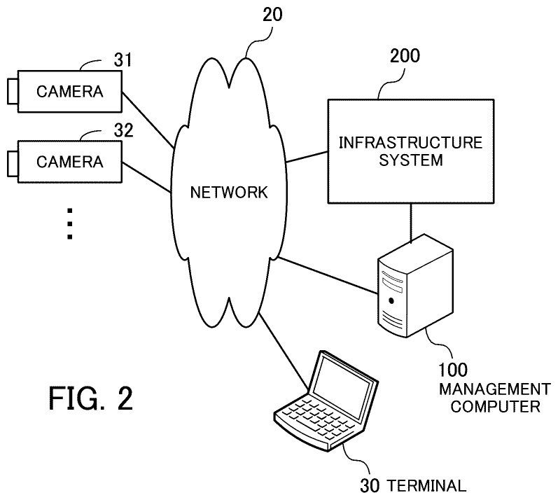

FIG. 2 illustrates an example of a system configuration according to the second embodiment. In the system illustrated in FIG. 2, an infrastructure system 200, a management computer 100, a terminal 30, and a plurality of cameras 31, 32, . . . are connected to a network 20. In addition, the infrastructure system 200 and the management computer 100 are directly connected to each other with a cable.

The infrastructure system 200 is a disaggregated computing system that allows for building servers that analyze data collected from an edge device group including the cameras 31, 32, . . . and others. For example, in the infrastructure system 200, a plurality of compute units and devices are connected via peripheral component interconnect (PCI) Express. PCI Express is hereinafter referred to as PCIe. The compute units include CPUs and memories. The devices are accelerators such as field programmable gate arrays (FPGAs), for example.

The management computer 100 is a computer that builds servers in the infrastructure system 200 according to DF definition information. The terminal 30 is a computer that sends the DF definition information to the management computer 100 in accordance with user instructions.

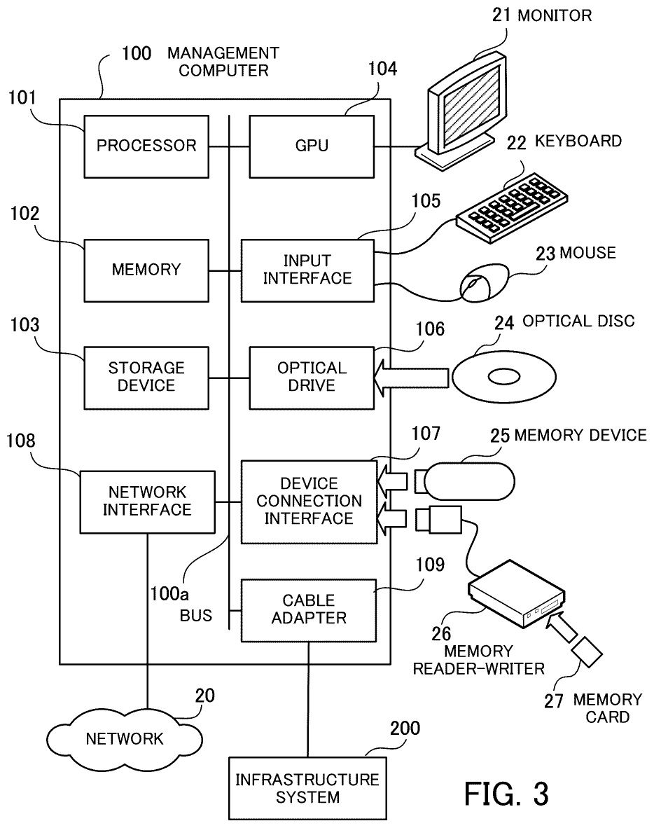

FIG. 3 illustrates an example of hardware of the management computer. The management computer 100 is entirely controlled by a processor 101. A memory 102 and a plurality of peripheral devices are connected to the processor 101 via a bus 100a. The bus 100a is PCIe, for example.

The processor 101 may be a multiprocessor. Each of the multiple processors may perform one or more, or all, of the processes performed by the management computer Optionally, different processors may perform different ones of the processes. The processor 101 may be referred to as “processor circuitry.” The processor 101 is, for example, a CPU, a micro processing unit (MPU), or a digital signal processor (DSP). At least one of functions that are implemented by the processor 101 running programs may be implemented by an electronic circuit such as an application specific integrated circuit (ASIC) or a programmable logic device (PLD).

The memory 102 is used as a main memory unit of the management computer 100. The memory 102 temporarily stores at least part of operating system (OS) programs and application programs being executed by the processor 101. In addition, the memory 102 stores various kinds of data being used by the processor 101 in processing. For example, a volatile semiconductor memory unit such as a random-access memory (RAM) is used as the memory 102.

The peripheral devices connected to the bus 100a include a storage device 103, a graphics processing unit (GPU) 104, an input interface 105, an optical drive 106, a device connection interface 107, a network interface 108, and a cable adapter 109.

The storage device 103 electrically or magnetically reads and writes data on its internal storage medium. The storage device 103 is used as an auxiliary memory unit of the management computer 100. The storage device 103 stores OS programs, application programs, and various kinds of data. For example, a hard disk drive (HDD) or a solid-state drive (SSD) may be used as the storage device 103.

The GPU 104 is a compute device that performs image processing, and is sometimes called a graphic controller. A monitor 21 is connected to the GPU 104. The GPU 104 displays images on the screen of the monitor 21 in accordance with commands from the processor 101. Examples of the monitor 21 include an organic electro-luminescence (EL) display device and a liquid crystal display device.

A keyboard 22 and a mouse 23 are connected to the input interface 105. The input interface 105 sends signals received from the keyboard 22 and the mouse 23 to the processor 101. The mouse 23 is an example of a pointing device, and another type of pointing device may be used, such as a touch panel, a tablet, a touchpad, or a trackball.

The optical drive 106 uses laser light or the like to read and write data on an optical disc 24. The optical disc 24 is a portable storage medium on which data has been recorded such that the data is readable by optical reflection. Examples of the optical disc 24 include a digital versatile disc (DVD), a DVD-RAM, a compact disc read-only memory (CD-ROM), and a CD-recordable (CD-R), and a CD-rewritable (CD-RW).

The device connection interface 107 is a communication interface that connects peripheral devices to the management computer 100. For example, a memory device 25 and a memory reader-writer 26 may be connected to the device connection interface 107. The memory device 25 is a storage medium having a function of communicating with the device connection interface 107. The memory reader-writer 26 is a device that reads and writes data on a memory card 27, which is a card-type storage medium.

The network interface 108 is connected to the network 20. The network interface 108 exchanges data with other computers or communication devices over the network 20. The network interface 108 is a wired communication interface connected to a wired communication device such as a switch or a router with a cable, for example. Alternatively, the network interface 108 may be a wireless communication interface that uses radio waves for communication with a wireless communication device such as a base station or an access point.

The cable adapter 109 is an adapter card that allows for connection with an external device via PCIe over a cable. Such an adapter card is sometimes called a host interface board. The cable adapter 109 is connected to the infrastructure system 200 with a PCIe cable.

The management computer 100 with the above-described hardware is able to implement the processing functions described in the second embodiment. In this connection, the apparatus described in the first embodiment may be configured with the same hardware as illustrated for the management computer 100 in FIG. 3.

The management computer 100 implements the processing functions of the second embodiment by, for example, running programs stored in a computer-readable storage medium. The programs describing the processing functions to be executed by the management computer 100 may be stored in a variety of storage media. For example, the programs that run on the management computer 100 may be stored in the storage device 103. The processor 101 loads at least part of a program from the storage device 103 into the memory 102 and runs the loaded program. The programs that run on the management computer 100 may be stored in the optical disc 24, memory device 25, memory card 27, or another portable storage medium. The programs stored in such a portable storage medium are installed in the storage device 103, for example, under the control of the processor 101, so that they are ready to run. In addition, the processor 101 is able to run the programs while reading the programs directly from the portable storage medium.

The following describes a hardware configuration of the infrastructure system.

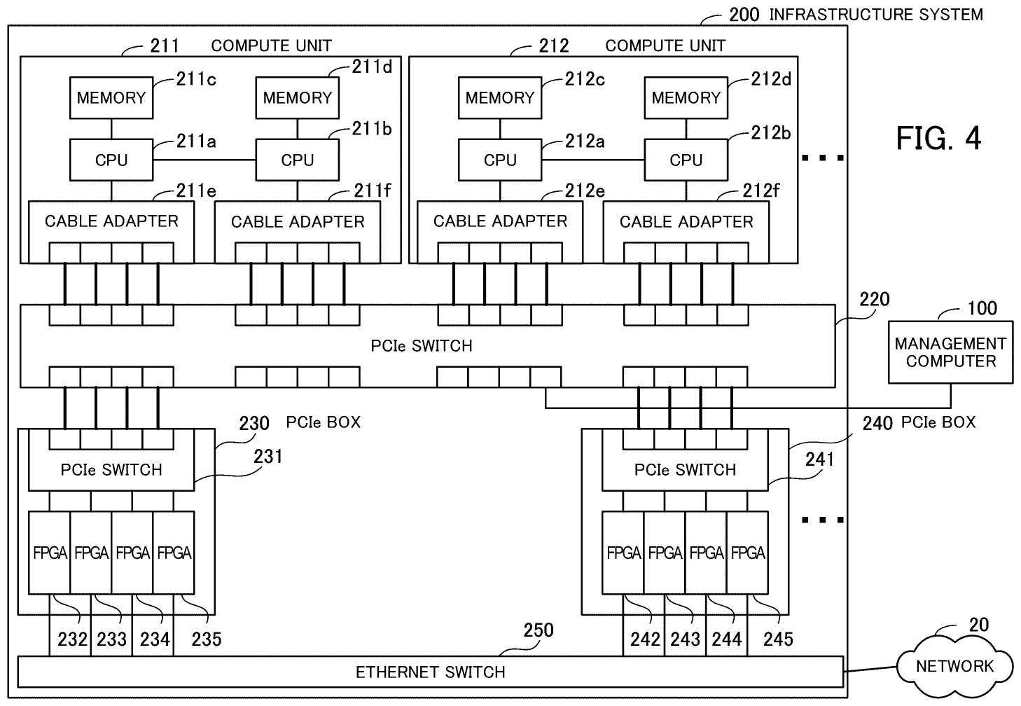

FIG. 4 illustrates an example of hardware configuration of the infrastructure system. The infrastructure system 200 includes compute units 211, 212, . . . , a PCIe switch 220, PCIe BOXes 230, 240, . . . , and an Ethernet switch 250.

The compute unit 211 includes CPUs 211a and 211b, memories 211c and 211d, and cable adapters 211e and 211f. The memory 211c is connected to the CPU 211a. The memory 211d is connected to the CPU 211b. Each CPU 211a and 211b, when incorporated in an LSN, manages the other resources included in the LSN. Each cable adapter 211e and 211f is an adapter that connects external devices to PCIe with cables.

The compute unit 212 includes CPUs 212a and 212b, memories 212c and 212d, and cable adapters 212e and 212f. The memory 212c is connected to the CPU 212a. The memory 212d is connected to the CPU 212b. Each CPU 212a and 212b, when incorporated in an LSN, manages the other resources included in the LSN. Each cable adapter 212e and 212f is an adapter card that is inserted into a PCIe slot to connect external devices to PCIe with cables.

The PCIe switch 220 has a plurality of ports, to which PCIe cables are connected. The compute units 211, 212, . . . , PCIe BOXes 230, 240, . . . , management computer 100, and others are connected to the ports of the PCIe switch 220. The PCIe switch 220 routes data received via the ports over the connected PCIe cables to the ports connected to the destination devices.

The PCIe switch 220 is connected to each compute unit 211, 212, . . . with a PCIe cable that has a predetermined number of lanes used. Likewise, the PCIe switch 220 is connected to each PCIe BOX 230, 240, . . . with a PCIe cable that has a predetermined number of lanes used.

The PCIe BOX 230 includes a PCIe switch 231 and FPGAS 232 to 235. Each FPGA 232 to 235 is connected to the PCIe switch 231 and the Ethernet switch 250. For example, each FPGA 232 to 235 is a card-type module and is inserted into a slot of the PCIe switch 231. In addition, each FPGA 232 to 235 has an Ethernet connection port, and a cable runs from the Ethernet connection port to the Ethernet switch 250.

The PCIe BOX 240 includes a PCIe switch 241 and FPGAS 242 to 245. Each FPGA 242 to 245 is connected to the PCIe switch 241 and the Ethernet switch 250. For example, each FPGA 242 to 245 is a card-type module and is inserted into a slot of the PCIe switch 241. In addition, each FPGA 242 to 245 has an Ethernet connection port, and a cable runs from the Ethernet connection port to the Ethernet switch 250.

The Ethernet switch 250 is connected to the FPGAs 232 to 235 of the PCIe Box 230, the FPGAs 242 to 245 of the PCIe BOX 240, and the network 20. The Ethernet switch 250 relays data communication between the FPGAs 232 to 235 and 242 to 245, and also sends data received from the cameras 31, 32 . . . connected thereto over the network 20 to the FPGAs 232 to 235 and 242 to 245.

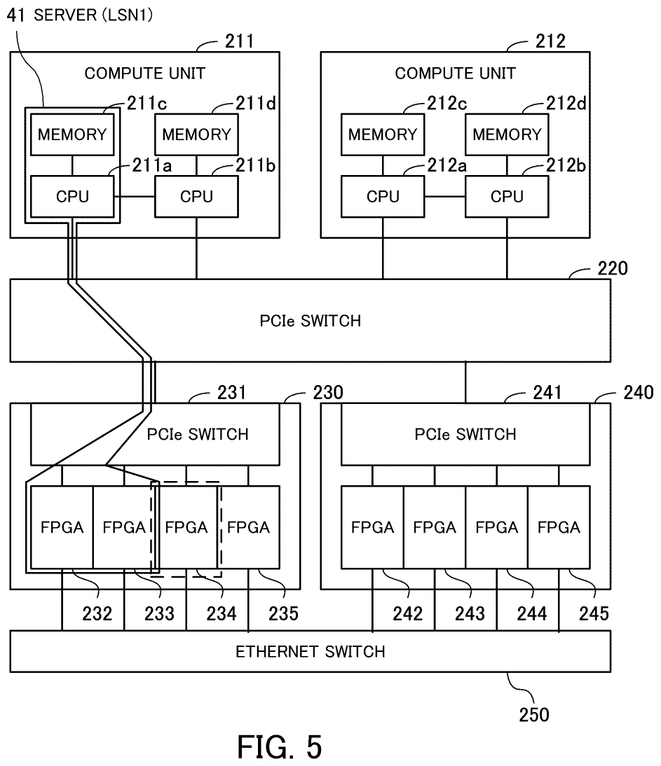

In the system illustrated in FIGS. 2 to 4, an LSN is built using disaggregation. In building an LSN, the selection and incorporation of inappropriate devices in the LSN results in reducing the processing efficiency of a server that runs on the LSN. The following describes what causes the reduction in the processing efficiency of the server, with reference to FIGS. 5 to 12.

FIG. 5 illustrates an example of a server that runs on an LSN. A server 41 runs on an LSN named “LSN1.” The “LSN1” includes the CPU 211a, memory 211c, and FPGAs 232 and 233. If the processing power of the “LSN1” is insufficient for the server 41 to run, for example, the FPGA 234 is added to the “LSN1.”

That is, the disaggregated environment, in accelerators such as the FPGAs 232 to 235 and 242 to 245 are separated and pooled at the device level. Compute elements (CPUs and memories) and devices are combined to build the LSN. Then, the server 41 runs on the built LSN. It is possible to add one or more devices to the LSN to enhance the performance of the server 41.

In addition, two types of communication paths, paths over PCIe-based interconnect communication and paths over Ethernet-based network communication, are provided for the communications between the devices provided in the infrastructure system 200.

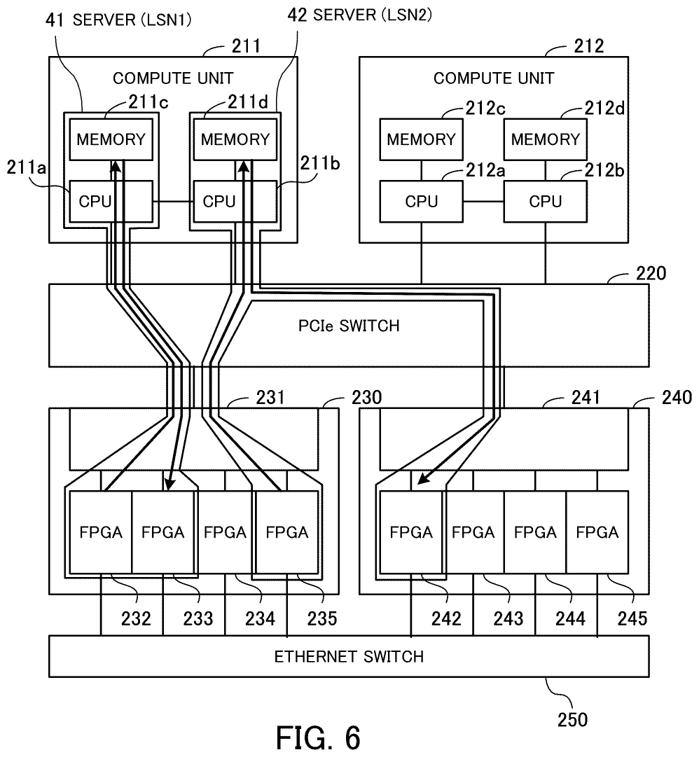

FIG. 6 illustrates examples of inter-device communication. The FPGAs 232 and 233 in the same server 41 exchange data using direct memory access (DMA) transfer over PCIe. For example, the FPGA 232 sends data to the memory 211c using DMA, and then the FPGA 233 receives the data from the memory 211c using DMA.

Although the FPGAs 232 and 233 in the server 41 are located in the same PCIe BOX 230, devices from different PCIe BOXes may be combined to build an LSN. For example, an LSN named “LSN2” that runs a server 42 includes the FPGA 235 in the PCIe BOX 230 and the FPGA 242 in the PCIe BOX 240. The FPGA 235 and the FPGA 242 are able to exchange data using DMA transfer via the memory 211d in the server 42.

Data communication using DMA transfer over PCIe as illustrated in FIG. 6 achieves high-speed data transfer. In addition, the DMA transfer does not put load on CPUs. Note, however, that the DMA transfer over PCIe is applicable only to the communications between the devices within the same server. To address this, the versatile Ethernet is available in the infrastructure system 200.

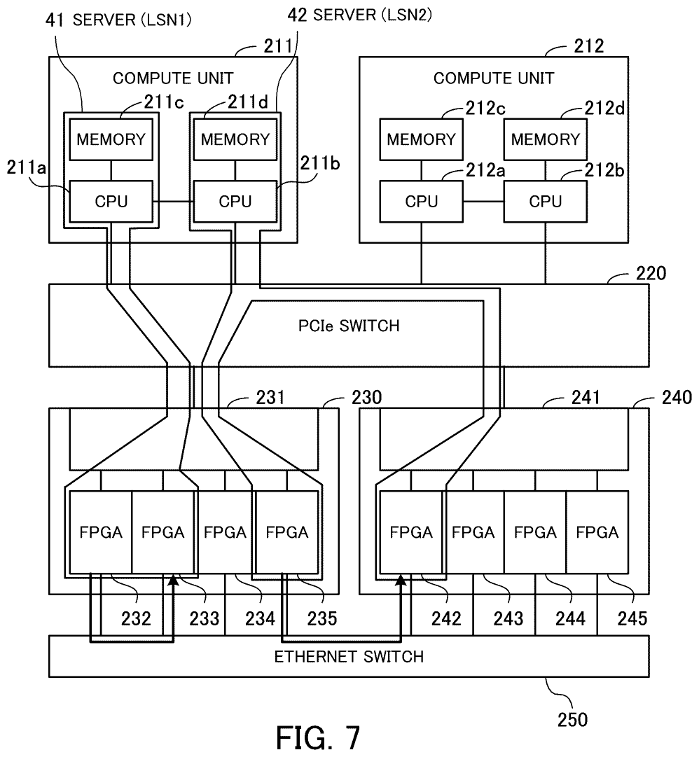

FIG. 7 illustrates examples of inter-device communication using Ethernet. As illustrated in FIG. 7, the FPGAs 232 and 233 in the server 41 are able to communicate with each other, both via PCIe and via the Ethernet switch 250. Likewise, the FPGAs 235 and 242 in the server 42 are able to communicate with each other, both via PCIe and via the Ethernet switch 250. The communication through the Ethernet switch 250 is transmission control protocol (TCP) packet communication, for example. The Ethernet has lower bandwidth and higher latency than PCIe, but is applicable for both intra-server communication and inter-server communication.

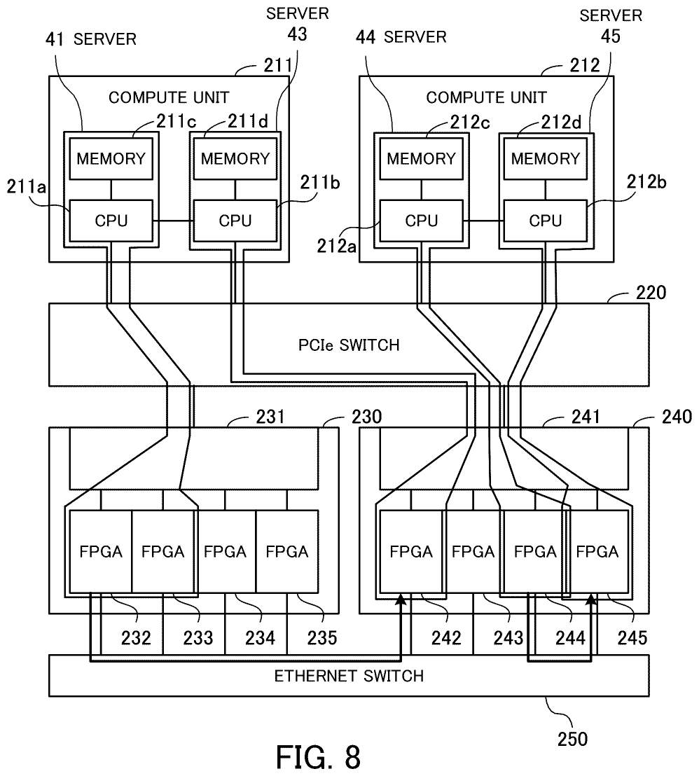

FIG. 8 illustrates examples of communication between devices in different servers. Referring to FIG. 8, as an example, the FPGA 232 in the server 41 and the FPGA 242 in a server 43 perform network communication through the Ethernet switch 250. As another example, the FPGA 244 in a server 44 and the FPGA 245 in a server 45 perform network communication through the Ethernet switch 250. That is, the inter-device communication between different servers is limited to the network communication.

In this connection, the communication speed between communicating devices depends on whether these devices are able to perform PCIe-based interconnect communication. In addition, interconnect communication with fewer intervening PCIe switches enables more efficient data transfer.

The management computer 100 has an infrastructure system manager to manage the configurations of LSNs that run servers.

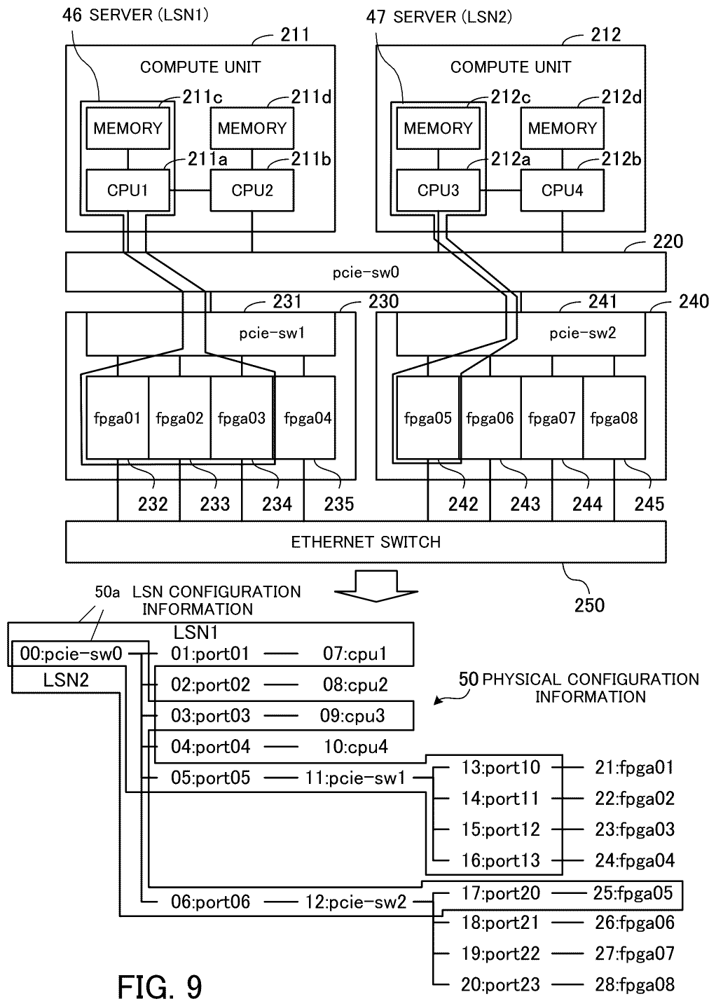

FIG. 9 illustrates example of how the configurations of LSNs are managed. For example, the management computer 100 has physical configuration information 50 indicating the resources (CPUs and devices) provided in the infrastructure system 200 and the connections between the resources. For example, in the physical configuration information 50, the connections between the resources are represented in a tree structure with the PCIe switch 220 as a root. In the tree structure, the identifiers of the ports of the PCIe switch 220 are set as children of the PCIe switch 220 named “pcie-sw0.” As a child of the identifier of each port, the name of a resource or PCIe switch connected to the port is set. In the case where a PCIe switch is connected to the port, the identifiers of the ports of the PCIe switch are set as children of the PCIe switch set using its name. In the case where another resource or PCIe switch is connected to a port of a PCIe switch, the name of the connected resource or PCIe switch is set as the child of the port set using its identifier.

LSN configuration information 50a specifies, for each built LSN, the resources included in the LSN. Referring to the example of FIG. 9, the LSN configuration information 50a indicates the configurations of the LSNs corresponding to two servers 46 and 47. For the configuration of an LSN, the LSN configuration information 50a specifies the elements included in the LSN among the elements indicated in the physical configuration information 50.

Note that the management computer 100 manages information on the specifications, status, and others of each device, in addition to the physical configuration information 50 and LSN configuration information 50a. For example, the information on the status of a device indicates whether the device is used as a component of an LSN.

An LSN is built on the basis of a DF defining a series of processes to be performed by a server. The DF defines a plurality of functions. Devices are allocated to the functions included in the DF, to execute the functions.

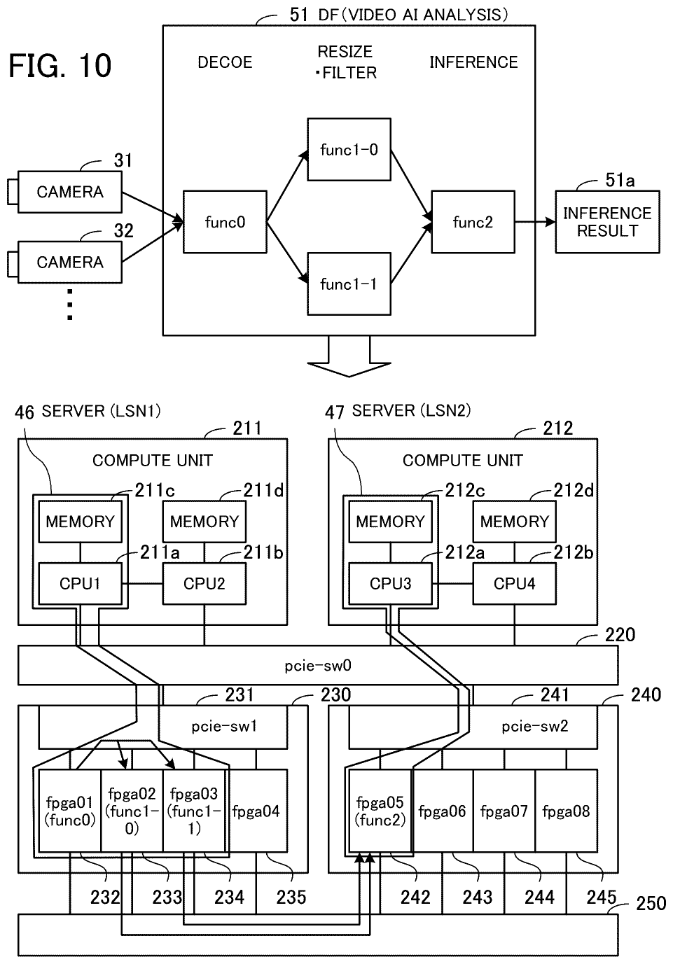

FIG. 10 illustrates an example of device allocation to functions. FIG. 10 illustrates an example of a DF 51 for video artificial intelligence (AI) analysis. The DF 51 includes a plurality of functions. A function “func0” receives image data captured by the cameras 31, 32, . . . and decodes the image data. Functions “func1-0” and “func1-1” resize (enlarge or reduce) and filter the images. A function “func2” performs AI inference on the resized and filtered images (for example, to determine whether there is any danger in the images captured by a surveillance camera in a town). The result of performing the processes based on the DF is output as an inference result 51a.

Assume that the processes based on the DF 51 are performed by the servers 46 and 47. In this case, since large data analysis and video and image processing are performed, the management computer 100 uses devices that achieve high-speed computing, for the functions. For example, the FPGA 232 is allocated to the function “func0.” The FPGA 233 is allocated to the function “func1-0,” the FPGA 234 is allocated to the function “func1-1,” and the FPGA 242 is allocated to the function “func2.”

For high-speed inter-function communication, it is desired, considering only the communication speed, to perform inter-device communication without involving a CPU. Therefore, PCIe communication is performed between devices (between the FPGAs 232 to 234) that have two types of communication paths therebetween, via PCIe and via Ethernet. On the other hand, communication through the Ethernet switch 250 is performed between devices (between the FPGA 233 and FPGA 242 and between the FPGA 234 and FPGA 242) in the different servers 46 and 47.

In allocating devices to functions, however, if the management computer 100 allocates available devices to the functions simply, it may severely impair the performance.

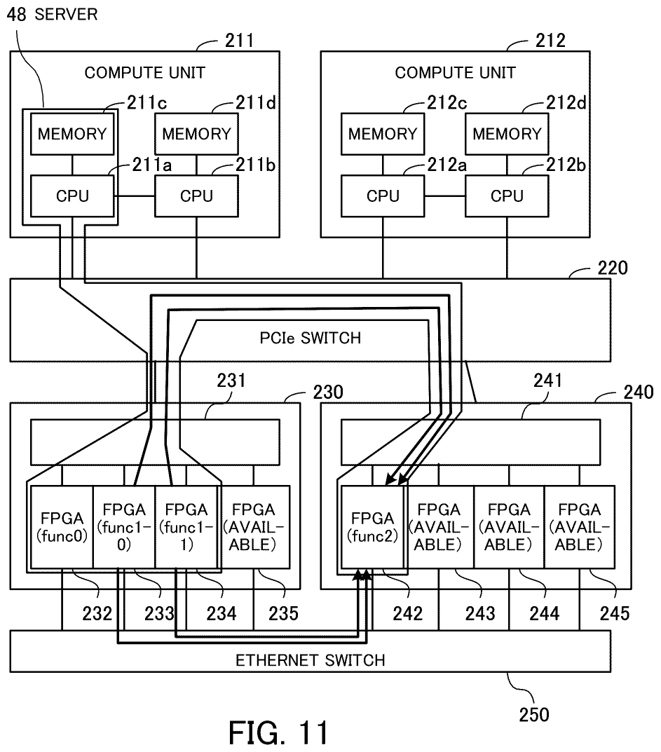

FIG. 11 illustrates an example of an increase in communication latency due to a long communication path. A server 48 includes the FPGAs 232 to 234 in the PCIe BOX 230 and the FPGA 242 in the PCIe BOX 240. In the case where the server 48 is used to perform the processes based on the DF 51 illustrated in FIG. 10, one of the devices in the server 48 is allocated to each function included in the DF 51. Referring to the example of FIG. 11, the FPGA 232 is allocated to the function “func0.” The FPGA 233 is allocated to the function “func1-0.” The FPGA 234 is allocated to the function “func1-1.” The FPGA 242 is allocated to the function “func2.”

In this case, each FPGA 233 and 234 sends the result of executing the corresponding function to the FPGA 242. To this end, each FPGA 233 and 234 is able to use a communication path through the PCIe switches 220, 231, and 241 and a communication the Ethernet switch 250. In general, the communication path through the PCIe switches 220, 231, and 241 enables faster communication. Therefore, each FPGA 233 and 234 sends data through the communication path via the PCIe switches 220, 231, and 241. This communication path, however, passes through many intervening PCIe switches and has high communication latency, compared with the inter-device communication within the same PCIe BOX. This therefore results in increasing delays in the processes based on the DF 51.

In building an LSN and allocating devices to functions, simply allocating available devices to the functions may result in the allocation illustrated in FIG. 11. That is, devices that are physically distant from each other (with many intervening PCIe switches) may be allocated to functions adjacent to (communicating with) each other in the DF 51. As a result of this allocation, there causes high communication latency between the devices, which leads to increasing delays in the processes based on the DF 51.

In addition, the communication speed between devices in a deployed server also depends on the communication conditions of other servers.

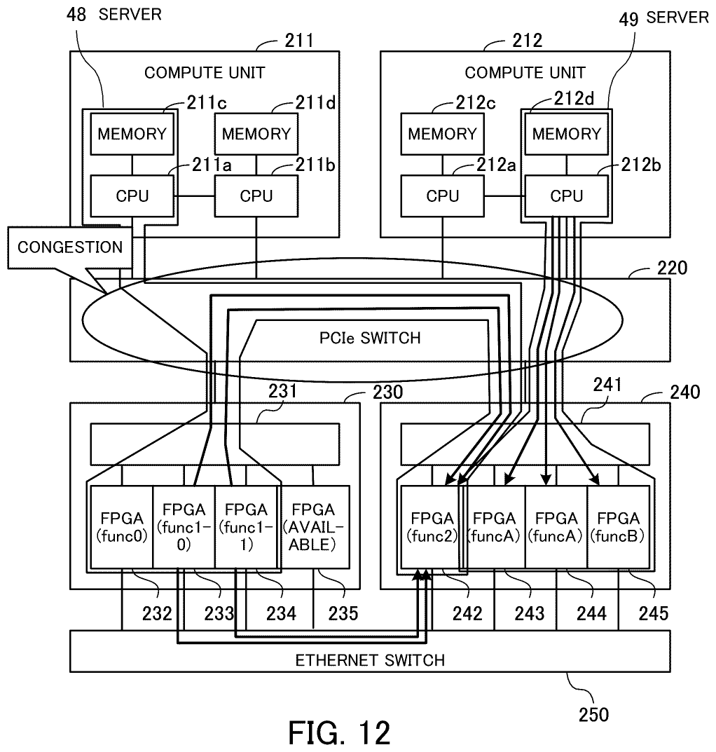

FIG. 12 illustrates an example of an increase in communication latency due to the communication of another server. Referring to the example of FIG. 12, a server 49, which is different from the server 48, is deployed before the server 48 is deployed. The server 49 includes the FPGAs 243 to 245 in the PCIe BOX 240. In this server 49, communications through the PCIe switches 220 and 241 take place between the CPU 212b and each FPGA 243 to 245. In addition, communications through the PCIe switches 220 and 241 also take place when the FPGAs 243 to 245 communicate with each other using DMA transfer via the memory 212d.

In the case where the server 48 is newly deployed in this situation, there may be lack of sufficient communication bandwidth for the inter-device communications through the PCIe switch 220 in the server 48 due to the communications of the server 49. As a result, the communication latency may exceed the time allowed for the series of processes to be performed by the server 48.

Although FIG. 12 illustrates an example in which only one server 49 is deployed before the server 48 is deployed, many other servers may already be deployed. In the case where the server 48 is newly deployed in this situation, a path shared by many other servers may be selected for the new server 48. This increases the risk that inter-device communications fail to satisfy the performance requirements (bandwidth, communication latency) thereof due to congestion.

Especially, inter-device communications often need to be high-speed. If a communication path is set, without taking into account the communication paths used by the other servers, communications may be concentrated on a PCIe communication path. Congestion, if occurs on the communication path, degrades the communication performance of not only the server 48 to be deployed but also all servers sharing the path.

To avoid this, when newly deploying a DF, the management computer 100 selects devices for the functions included in the DF and paths between the devices so as to reduce the communication latency, and builds a server. More specifically, the management computer 100 operates as follows.

### Device Selection

The management computer 100 allocates devices as close as possible to functions to be deployed. Firstly, for example, the management computer 100 selects devices to be allocated on a PCIe BOX basis. More specifically, the management computer 100 allocates devices in as few PCIe BOXes as possible to the plurality of functions included in a DF. At this time, the management computer 100 preferentially allocates devices in the same PCIe BOX to adjacent functions that need communication with high performance requirements (low latency). In other words, in the case where there is no choice but to deploy functions across PCIe BOXes, the management computer 100 allocates devices in different PCIe BOXes to a pair of functions that allow low-speed communication. Since devices in the same PCIe BOX have the shortest distance therebetween, functions to which the devices in the same PCIe BOX are allocated are able to perform high-speed communication.

### Communication Path Selection

The management computer 100 selects communication paths between functions so as to prevent the occurrence of congestion in communication through PCIe switches. For example, for a communication between the functions, the management computer 100 selects an Ethernet communication path so that the functions perform Ethernet communication if it satisfies the performance requirements of the communication. Even if the functions need PCIe communication, the management computer 100 selects the Ethernet communication path if communications are concentrated on the PCIe path (lack of free bandwidth).

### Server Design

The management computer 100 separate two adjacent functions in a DF into different servers if the two devices respectively allocated to these functions are not connectable via PCIe switches. Here, two devices that are not connectable via PCIe switches are devices that do not have a communication path through PCIe switches therebetween but are only connected to each other via the Ethernet switch 250.

The following describes the functions of the management computer 100 to perform appropriate device selection, communication path selection, and server design.

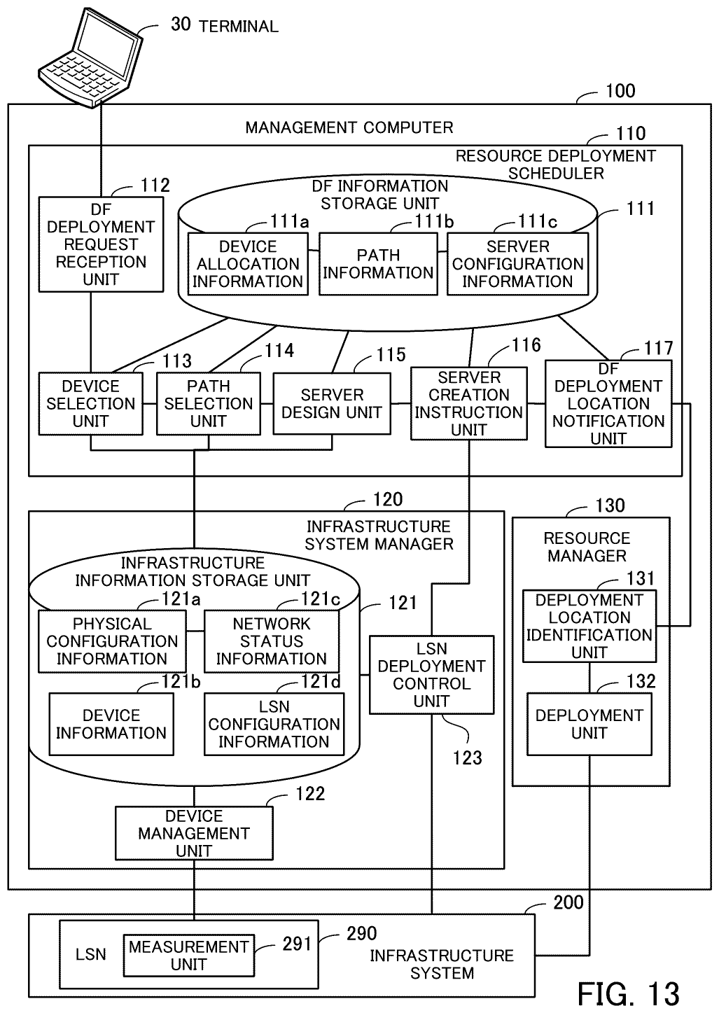

FIG. 13 is a block diagram illustrating an example of functions of the management computer. The management computer 100 has a resource deployment scheduler 110, an infrastructure system manager 120, and a resource manager 130.

With respect to a DF defining functions, the resource deployment scheduler 110 selects devices to be allocated to the functions, selects communication paths between the functions, and designs the configurations of servers that execute the functions. The resource deployment scheduler 110 includes a DF information storage unit 111, a DF deployment request reception unit 112, a device selection unit 113, a path selection unit 114, a server design unit 115, a server creation instruction unit 116, and a DF deployment location notification unit 117.

The DF information storage unit 111 stores information on the DF to be executed in the infrastructure system 200. For example, the DF information storage unit 111 stores device allocation information 111a, path information 111b, server configuration information 111c, and others. The device allocation information 111a indicates devices allocated to the functions. The path information 111b indicates communication paths used for the communications between the functions. The server configuration information 111c indicates the configurations of the servers.

The DF deployment request reception unit 112 receives a DF deployment request from the terminal 30. The DF deployment request includes DF definition information. The DF definition information defines the compositions of the functions included in the DF, the connections between the functions, and the performance requirements for the communications between the connected functions.

The device selection unit 113 selects devices to be allocated to the functions included in the DF, on the basis of the DF definition information included in the DF deployment request. The device selection unit 113 records the devices allocated to the functions in the device allocation information 111a.

The path selection unit 114 selects communication paths to be used for the communications between the functions. The path selection unit 114 records information on the selected communication paths in the path information 111b.

The server design unit 115 determines the configurations of the servers that execute the functions included in the DF. The server design unit 115 records information on the determined configurations of the servers in the server configuration information 111c.

The server creation instruction unit 116 instructs the infrastructure system manager 120 to create the servers.

The DF deployment location notification unit 117 notifies the resource manager 130 of the deployment location of each function included in the DF and the communication paths between the functions.

The infrastructure system manager 120 deploys LSNs in the infrastructure system 200. The infrastructure system manager 120 includes an infrastructure information storage unit 121, a device management unit 122, and an LSN deployment control unit 123.

The infrastructure information storage unit 121 stores information on the infrastructure system 200. The information stored in the infrastructure information storage unit 121 is an example of the system information 11a (see FIG. 1) described in the first embodiment. For example, the infrastructure information storage unit 121 stores physical configuration information 121a, device information 121b, network status information 121c, and LSN configuration information 121d. The physical configuration information 121a indicates the hardware configuration of the infrastructure system. The device information 121b indicates the types, statuses, and others of devices. The network status information 121c indicates the communication status of PCIe or Ethernet network. The LSN configuration information 121d indicates the configurations of built LSNs.

The device management unit 122 manages the operational status of each device in the infrastructure system 200. For example, the device management unit 122 obtains information indicating the data communication status between the devices from the infrastructure system 200. For example, an LSN 290 built in the infrastructure system 200 includes a measurement unit 291. The measurement unit 291 sends measured data traffic volumes between devices to the device management unit 122. The device management unit 122 then updates the network status information 121c on the basis of the obtained data traffic volumes.

The LSN deployment control unit 123 deploys the LSNs in the infrastructure system 200 in response to a server creation instruction from the resource deployment scheduler 110, and runs the servers on the LSNs.

The resource manager 130 deploys the functions at the devices in the infrastructure system 200 according to a deployment location notification received from the DF deployment location notification unit 117. The resource manager 130 includes a deployment location identification unit 131 and a deployment unit 132.

The deployment location identification unit 131 interprets information on DF deployment, received from the DF deployment location notification unit 117. The deployment unit 132 deploys the functions included in the DF at the devices of the infrastructure system on the basis of the a interpretation result. In this connection, deploying function means implementing the execution capability of the function on a device so as to make the function executable.

It is noted that, while lines interconnecting elements in FIG. 13 represent some communication paths, there may be other communication paths than the illustrated ones. In addition, for example, the functionality of each element illustrated in FIG. 13 may be achieved by a computer executing the program module corresponding to the element.

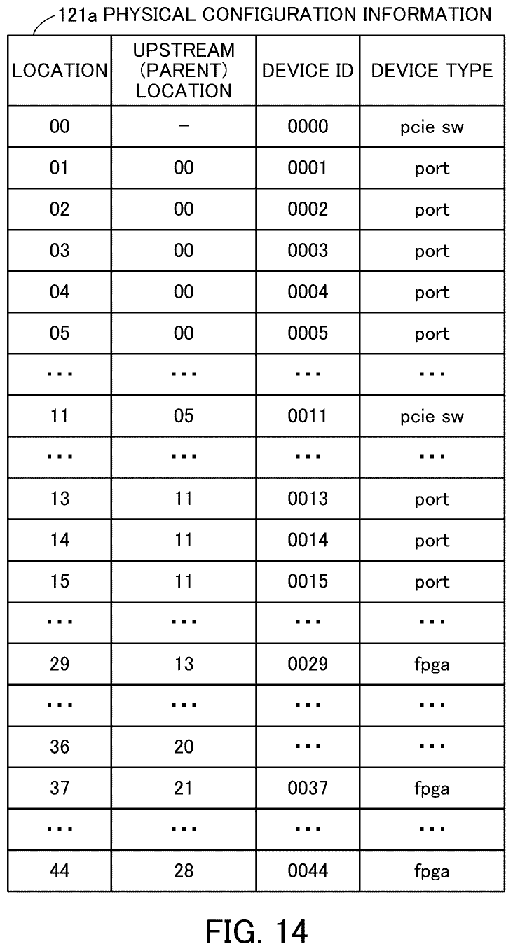

The following describes data to be used in the deployment of a DF in detail with reference to FIGS. 14 to 20.

FIG. 14 illustrates an example of the physical configuration information. The physical configuration information 121a includes records corresponding respectively to PCIe switches, the ports of the PCIe switches, and FPGAs. Each record contains the following data: Location, Upstream (Parent) Location, Device ID, and Device Type.

The Location contains an identifier identifying the location of a device in the hardware configuration. The Upstream (Parent) Location indicates the location of the upstream (parent) device of the device. The parent of a port is a switch that has the port. The parent of a PCIe switch is the port of an upstream PCIe switch connected to the PCIe switch. The parent of an FPGA is the port of a PCIe switch connected to the FPGA. The Device ID contains the identifier of the device. The Device Type indicates the type of the device. Here, the Device Type contains one of “pcie sw” indicating PCIe switch, “port” indicating port of PCIe switch, and “fpga” indicating FPGA.

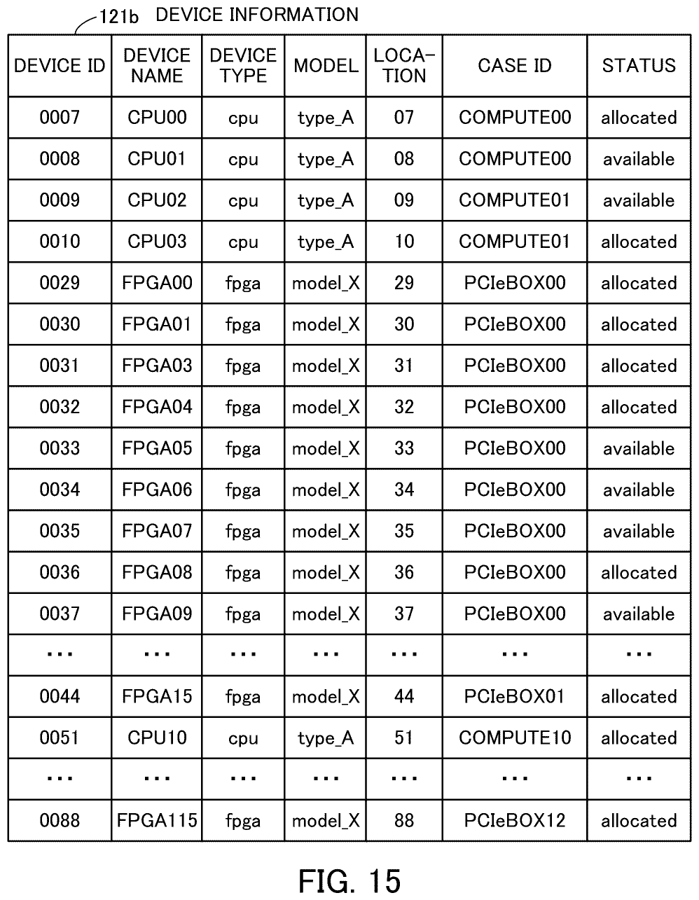

FIG. 15 illustrates an example of the device information. The device information 121b includes records corresponding respectively to CPUs and FPGAs. Each record contains the following data: Device ID, Device Name, Device Type, Model, Location, Case ID, and Status.

The Device ID contains the identifier of a device. The Device Name indicates the name of the device. The Device Type indicates the type of the device. Here, the Device Type contains one of “cpu” indicating CPU and “fpga” indicating FPGA. The Model indicates the model name of the device. The Location contains an identifier identifying the location of the device in the hardware configuration. The Case ID contains the identifier of a compute unit or PCIe box where the device is mounted. The Status indicates whether or not the device is already allocated to an LSN. Here, the Status contains one of “allocated” indicating that the device is already allocated to an LSN, and “available” indicating that the device has not been allocated to any LSN.

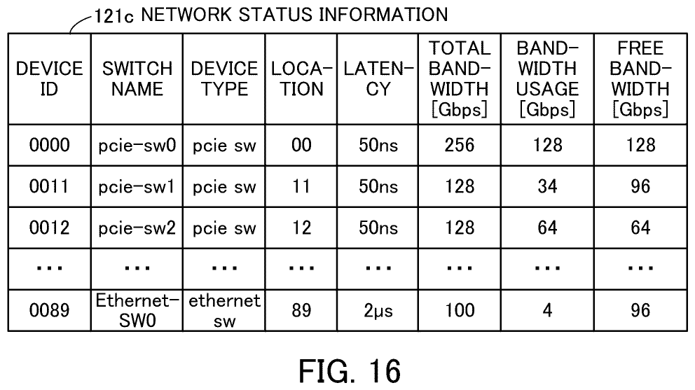

FIG. 16 illustrates an example of the network status information. The network status information 121c includes records corresponding respectively to PCIe switches and Ethernet switch. Each record contains the following data: Device ID, Switch Name, Device Type, Location, Latency, Total Bandwidth, Bandwidth Usage, and Free Bandwidth.

The Device ID contains the identifier of a device. The Switch Name indicates the name of a PCIe switch or Ethernet switch. The Device Type indicates the type of the device. Here, the Device Type contains one of “pcie sw” indicating PCIe switch and “ethernet sw” indicating Ethernet switch. The Location contains an identifier identifying the location of the device in the hardware configuration.

The Latency indicates the latency of communication via the corresponding device. The Total Bandwidth indicates the total bandwidth (the maximum data transfer capacity) in Gbps of the corresponding device. The Bandwidth Usage indicates a data transfer capacity in Gbps used in the corresponding device. The Free Bandwidth indicates the difference between the total bandwidth and the bandwidth usage of the corresponding device in Gbps.

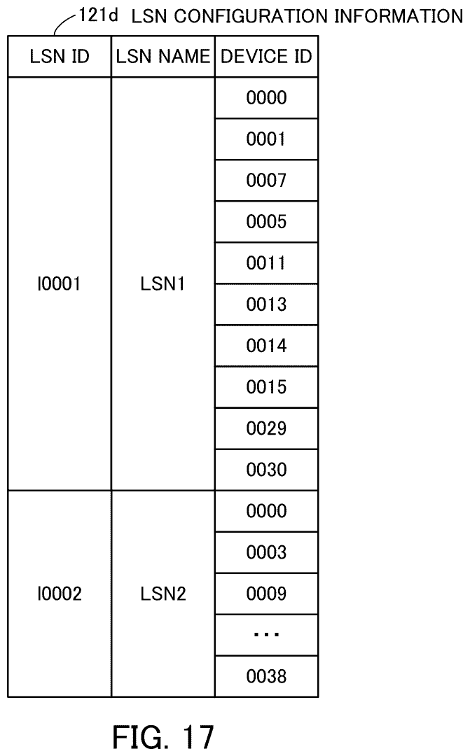

FIG. 17 illustrates an example of the LSN configuration information. The LSN configuration information 121d includes a record for each LSN. Each record contains the following data: LSN ID, LSN Name, and Device ID.

The LSN ID contains the identifier of an LSN. The LSN Name indicates the name of the LSN. The Device ID lists the identifiers of the devices included in the LSN.

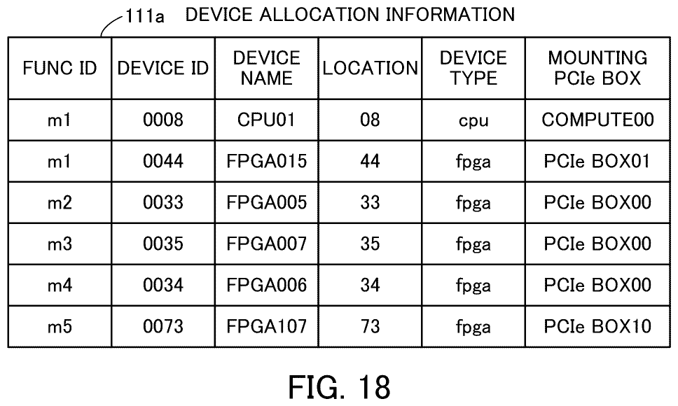

FIG. 18 illustrates an example of the device allocation information. The device allocation information 111a contains a record for each function included in a DF. Each record contains the following data: Func ID, Device ID, Device Name, Location, Device Type, and Mounting PCIe BOX.

The Func ID contains the identifier of a function. The Device ID contains the identifier of a device allocated to the function. The Device Name indicates the name of the device allocated to the function. The Location indicates the location of the device allocated to the function in the hardware configuration. The Device Type indicates the type of the device allocated to the function. The Mounting PCIe BOX indicates a PCIe BOX where the device allocated to the function is mounted.

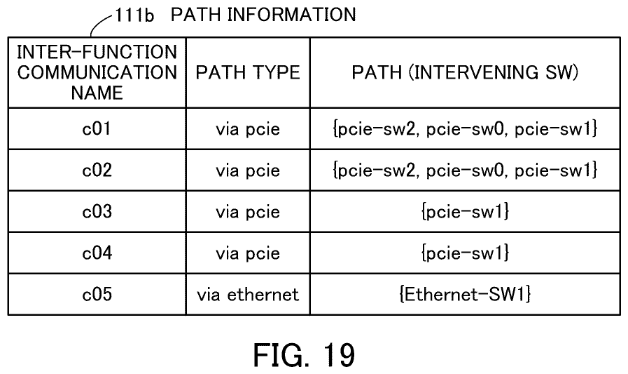

FIG. 19 illustrates an example of the path information. The path information 111b contains a record for each communication path between pairs of adjacent functions in a DF. Each record contains the following data: Inter-function Communication Name, Path Type, and Path (intervening SW).

The Inter-function Communication Name indicates the name of a communication path. The Path Type indicates the type of the communication path. Here, the Path Type contains one of “via pcie” indicating a communication path through PCIe switches and “via ethernet” indicating a communication path through the Ethernet switch. The Path (intervening SW) indicates the connection relationship between the devices on the communication path.

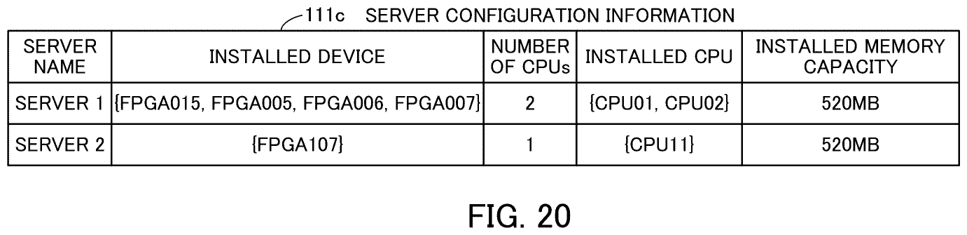

FIG. 20 illustrates an example of the server configuration information. The server configuration information 111c includes a record for each server. Each record contains the following data: Server Name, Installed Device, Number of CPUs, Installed CPU, and Installed Memory Capacity.

The Server Name indicates the name of a server. The Installed Device lists the device names of accelerator devices installed in the server. The Number of CPUs indicates the number of CPUs installed in the server. The Installed CPU lists the CPU names of CPUs installed in the server. The Installed Memory Capacity indicates the capacity of a memory installed as a main memory unit in the server.

On the basis of the data illustrated in FIGS. 14 to 20, the resource deployment scheduler 110 appropriately allocates devices to the functions indicated in a DF. For example, the resource deployment scheduler 110 generates server configuration information and DF deployment information on the basis of DF definition information.

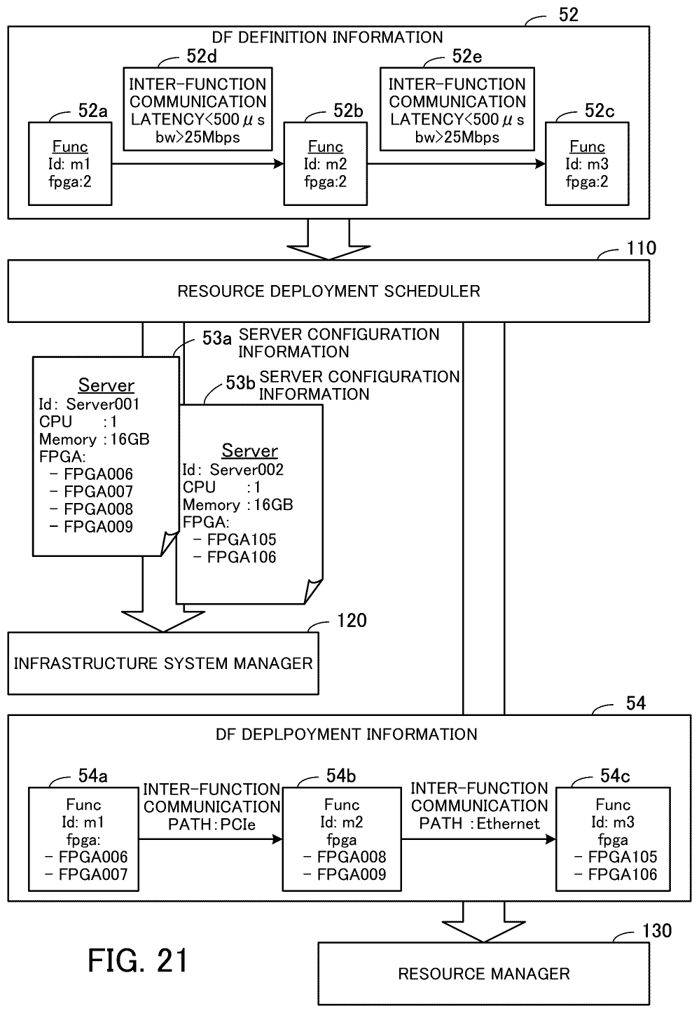

FIG. 21 illustrates an example of input and output data to and from the resource deployment scheduler. DF definition information 52 that is input to the resource deployment scheduler 110 includes function profiles 52a, 52b, and 52c. Each function profile 52a, 52b, and 52c includes the identifier “Id” of a function to be executed based on a DF, and the number of FPGAs to be used to execute the function. In addition, the DF definition information 52 associates the function profiles of communicating functions (adjacent functions) with each other (these functions are connected by a line in FIG. 21).

Inter-function communication information 52d and 52e is provided for the communication paths between adjacent functions. The inter-function communication information 52d and 52e specifies performance requirements. The performance requirements include, for example, an upper limit of latency and a lower limit of bandwidth, which are desired by the user instructing the deployment of the DF. The term “bandwidth” may be abbreviated as “bw” in the drawings.

The resource deployment scheduler 110 generates, upon receiving the DF definition information 52, server configuration information 53a and server configuration information 53b, each defining a server to execute the DF, and DF deployment information 54 indicating the details about the deployment of the DF to the servers. Each of the server configuration information 53a and server configuration information 53b indicates the configuration (the number of CPUs, memory capacity, and information on devices to be installed) of each server to be built for the DF. The DF deployment information 54 includes information (for example, device name) on the devices to be allocated to the functions indicated in the DF definition information 52, and the types (path types) of communication paths selected respectively as inter-function communication paths.

The resource deployment scheduler 110 sends the generated server configuration information 53a and 53b to the infrastructure system manager 120. The infrastructure system manager 120 then builds LSNs in the infrastructure system 200 on the basis of the server configuration information 53a and 53b, and causes the built LSNs to function as servers.

In addition, the resource deployment scheduler 110 sends the generated DF deployment information 54 to the resource manager 130. The resource manager 130 then deploys the DF in the servers in the infrastructure system 200 on the basis of the DF deployment information 54.

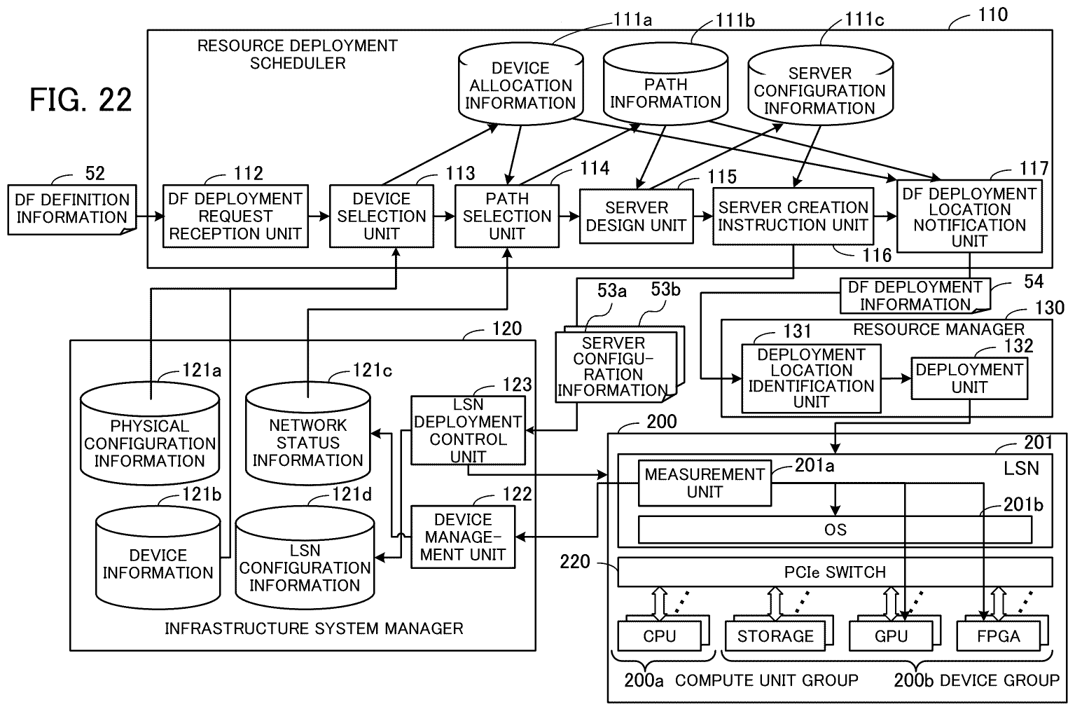

FIG. 22 illustrates flows of data in the management computer. The DF definition information 52 input to the resource deployment scheduler 110 is received by the DF deployment request reception unit 112. The DF deployment request reception unit 112 sends the received DF definition information 52 to the device selection unit 113. The device selection unit 113 determines devices to be allocated to functions indicated in the DF definition information 52, with reference to the physical configuration information 121a and device information 121b. The device selection unit 113 updates the device allocation information 111a.

When the device allocation based on the DF definition information 52 is complete, the path selection unit 114 selects communication paths between the functions with reference to the network status information 121c. The path selection unit 114 updates the path information 111b on the basis of the result of selecting the communication paths. When the selection of the communication paths is complete, the server design unit 115 designs the configurations of servers that execute the processes indicated in the DF. The server design unit 115 updates the server configuration information 111c on the basis of the determined server configurations.

The server creation instruction unit 116 creates, with reference to the server configuration information 111c, a server creation instruction including the server configuration information 53a and server configuration information 53b, each indicating a server configuration designed based on the DF definition information 52, and sends the server creation instruction to the infrastructure system manager 120. The server configuration information 53a and 53b is received by the LSN deployment control unit 123 in the infrastructure system manager 120. The LSN deployment control unit 123 builds the servers in the infrastructure system 200 on the basis of the server configuration information 53a and 53b. For example, the LSN deployment control unit 123 builds an LSN 201 in the infrastructure system 200. The LSN 201 is built by combining CPUs in a compute unit group 200a provided in the infrastructure system 200 and devices (storage, GPUS, FPGAs, and others) in a device group 200b provided in the infrastructure system 200.

The LSN deployment control unit 123 then installs an OS 201b in the built LSN 201. In addition, the LSN deployment control unit 123 causes the LSN 201 to operate as a server. In addition, the LSN deployment control unit 123 causes a measurement unit 201a to operate on the OS 201b. When the building of the LSN 201 is complete, the LSN deployment control unit 123 updates the LSN configuration information 121d.

The DF deployment location notification unit 117 generates the DF deployment information 54 on the basis of the device allocation information 111a and path information 111b, and sends a DF deployment notification including the DF deployment information 54 to the resource manager 130.

The resource manager 130 receives the DF deployment information 54 at the deployment location identification unit 131. The deployment location identification unit 131 identifies devices to be allocated to the functions included in the DF and communication paths between the functions on the basis of the DF deployment information 54. The deployment unit 132 causes the devices forming the LSN 201 to execute the corresponding functions on the basis of the identification result obtained by the deployment location identification unit 131. In addition, the deployment unit 132 sets, for each function, a communication path to another function on the basis of the identification result obtained by the deployment location identification unit 131.

When the LSN 201 starts to execute the functions based on the DF, the measurement unit 201a measures a communication load (for example, bandwidth usage) for each communication path. The device management unit 122 in the infrastructure system manager 120 obtains information on the communication loads measured by the measurement unit 201a and updates the network status information 121c.

The following describes, in detail, how the resource deployment scheduler 110 performs a resource deployment process.

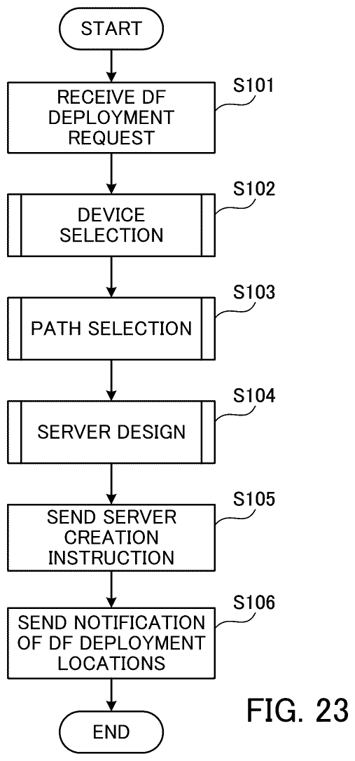

FIG. 23 is a flowchart illustrating an example procedure for the resource deployment process performed by the resource deployment scheduler. The process of FIG. 23 will be described step by step.

Step S101: The DF deployment request reception unit 112 receives a DF deployment request including DF definition information from the terminal 30. The DF deployment request reception unit 112 sends the DF definition information included in the received DF deployment request to the device selection unit 113.

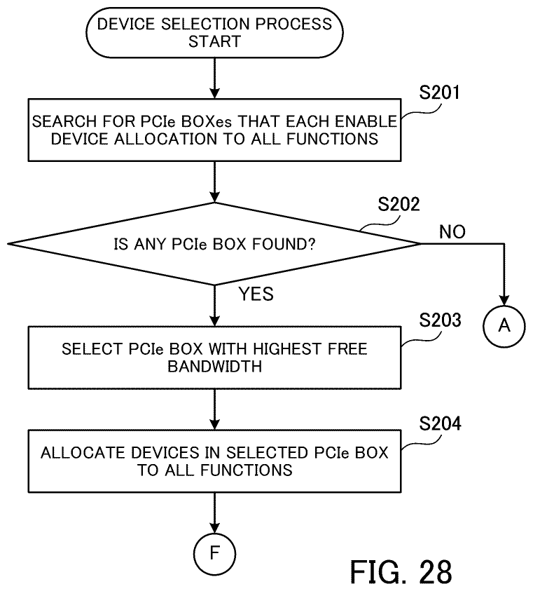

Step S102: The device selection unit 113 performs a device selection process to select devices to be allocated to the functions indicated in the DF definition information. This device selection process will be described in detail later (with reference to FIGS. 28 to 31).

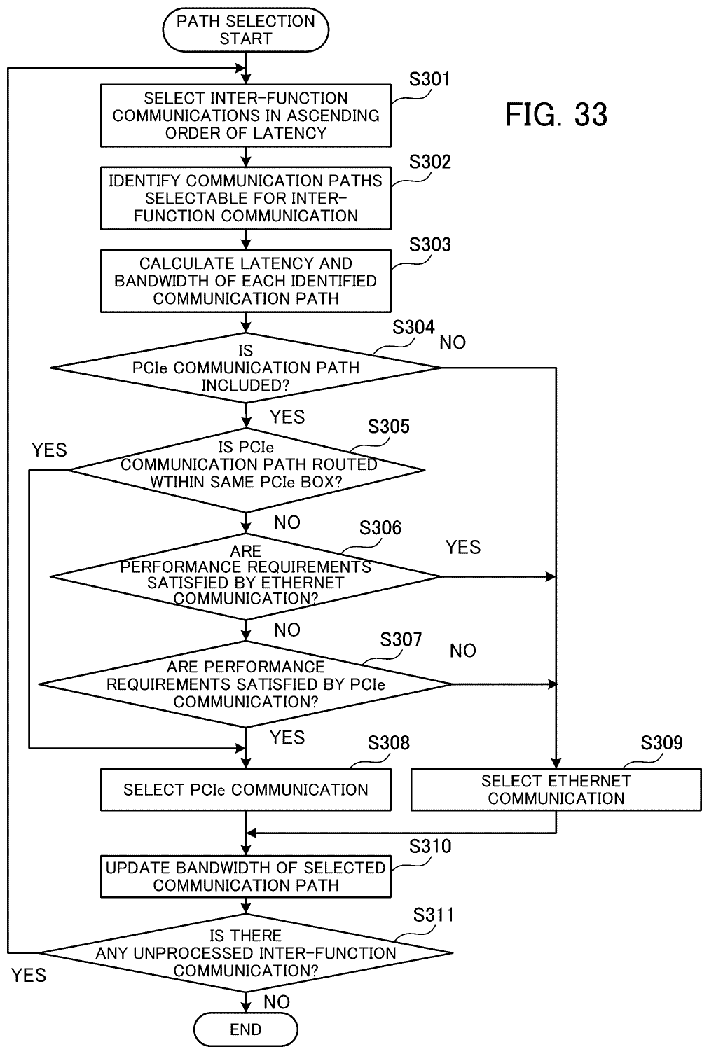

Step S103: The path selection unit 114 performs a path selection process. This path selection process will be described in detail later (with reference to FIG. 33).

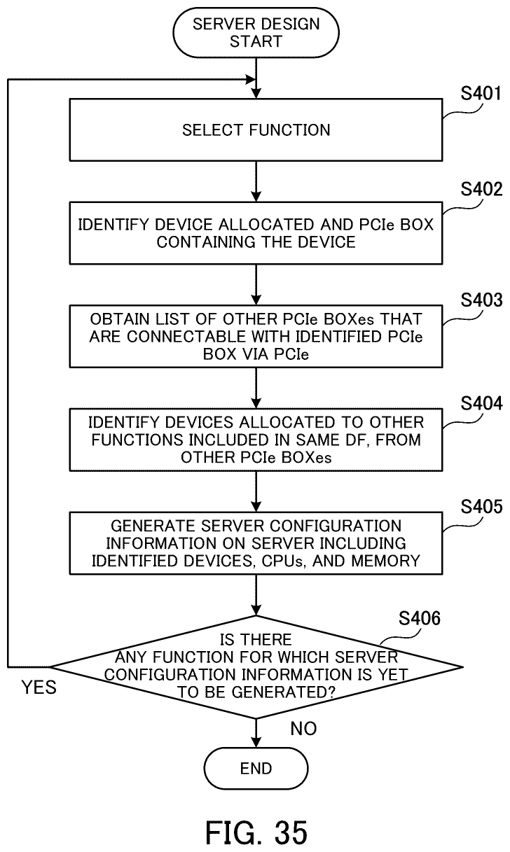

Step S104: The server design unit 115 performs a server design process. This server design process will be described in detail later (with reference to FIG. 35).

Step S105: The server creation instruction unit 116 sends a server creation instruction to the infrastructure system manager 120.

Step S106: The DF deployment location notification unit 117 notifies the resource manager 130 of DF deployment locations.

The resource deployment process is performed in accordance with the above procedure. The following describes the device selection process, the path selection process, and the server design process in detail.

The device selection process will first be described in detail.

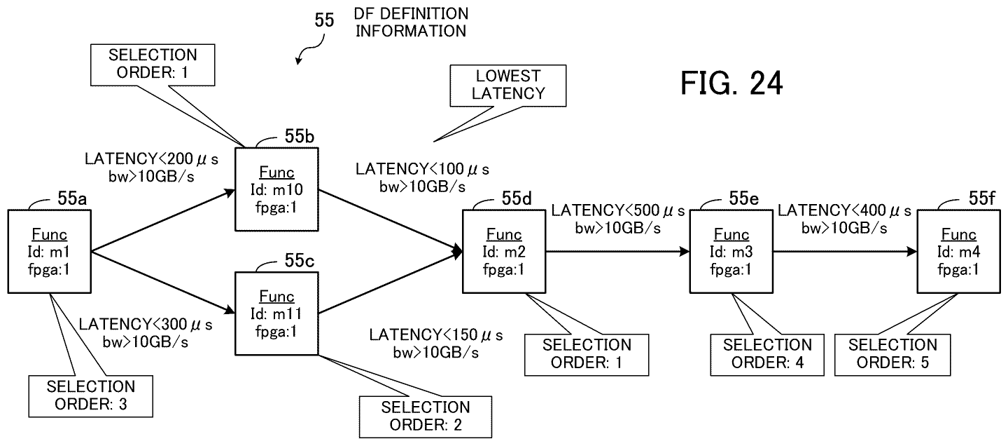

FIG. 24 illustrates an example of device selection. Assume, for example, that DF definition information 55 is input to the resource deployment scheduler 110. The DF definition information 55 includes the function profiles 55a to 55f of six functions. The function profile 55a defines a function “m1.” The function profile 55b defines a function “m10.” The function profile 55c defines a function “m11.” The function profile 55d defines a function “m2.” The function profile 55e defines a function “m3.” The function profile 55f defines a function “m4.”

The DF definition information 55 indicates that the function “m1” sends data to the functions “m10” and “m11.” The performance requirements for the communication path between the functions “m1” and “m10” include a latency less than “200 μs” and a bandwidth greater than “10 GB/s.” The performance requirements for the communication path between the functions “m1” and “m11” include a latency less than “300 μs” and a bandwidth greater than “10 GB/s.”

Both the functions “m10” and “m11” send data to the function “m2.” The performance requirements for the communication path between the functions “m10” and “m2” include a latency less than “100 μs” and a bandwidth greater than “10 GB/s.” The performance requirements for the communication path between the functions “m11” and “m2” include a latency less than “150 μs” and a bandwidth greater than “10 GB/s.”

The function “m2” sends data to the function “m3.” The performance requirements for the communication path between the functions “m2” and “m3” include a latency less than “500 μs” and a bandwidth greater than “10 GB/s.” The functions “m3” sends data to the function “m4.” The performance requirements for the communication path between the functions “m3” and “m4” include a latency less than “400 μs” and a bandwidth greater than “10 GB/s.”

When the above DF definition information 55 is input, first the device selection unit 113 selects devices to be allocated to the functions at both ends of the inter-function communication with the lowest latency in the performance requirements. For example, the DF definition information 55 indicates that the communication between the functions “m10” and “m2” needs the lowest latency. Therefore, the device selection unit 113 sets the selection order for the functions “m10” and “m2” to “1,” meaning that devices to be allocated to these functions are selected first.

Then, the device selection unit 113 selects a device to be allocated to a function adjacent to the functions selected first for the device allocation. If there are a plurality of functions adjacent to the functions, the device selection unit 113 selects the functions in order, starting with the function that needs an inter-function communication with the lowest latency in the performance requirements, and selects a device to the selected function. The DF definition information 55 indicates that there are three functions “m1,” “m11,” and “m3” adjacent to the function “m10” or the function “m2.” In ascending order of latency, these functions are arranged in the order of the function “m11,” the function “m1,” and then the function “m3.” The device selection unit 113 selects devices to be allocated to these functions in that order.

After that, the device selection unit 113 selects functions adjacent to the functions selected for the device allocation, in ascending order of latency in performance requirements, starting with the function that needs the lowest latency, and selects a device to the selected function. This process is repeated until there are no more functions that need to be selected for the device allocation. By doing so, the device selection unit 113 selects a device to be allocated to the function “m4.”

In the case of the DF definition information 55, the selection order of the functions for the device allocation is as follows: the first are “m10 and m2,” the second is “m11,” the third is “m1,” the fourth is “m3,” and the fifth is “m4.”

The rules for selecting devices to be allocated to functions are as follows.

First stage: The device selection unit 113 selects devices to be allocated to all functions from one PCIe BOX. If the device selection unit 113 has successfully selected devices for all functions, it completes this selection process. If a plurality of PCIe BOXes are found, which each enable the device allocation, the device selection unit 113 selects devices from the PCIe BOX that has a PCIe switch with the lowest bandwidth usage among the PCIe BOXes.

Second Stage: The device selection unit 113 selects devices from PCIe BOXes connected to each other via PCIe switches. If the device selection unit 113 has successfully selected devices for all functions, it completes this selection process. For example, with the PCIe BOX with the highest number of available devices as a starting PCIe BOX, the device selection unit 113 selects devices from the starting PCIe BOX and one or more other PCIe BOXes, while selecting the other PCIe BOXes in order, starting with the PCIe BOX with the shortest distance (with the fewest intervening PCIe switches) from the starting PCIe BOX.

Third Stage: The device selection unit 113 selects devices from PCIe BOXes connected to each other via only the Ethernet switch. If the device selection unit 113 has successfully selected devices for all functions, it completes this selection process.

Fourth Stage: Since there are no devices selectable, the device selection unit 113 terminates the selection process with error by concluding that the selection is not possible.

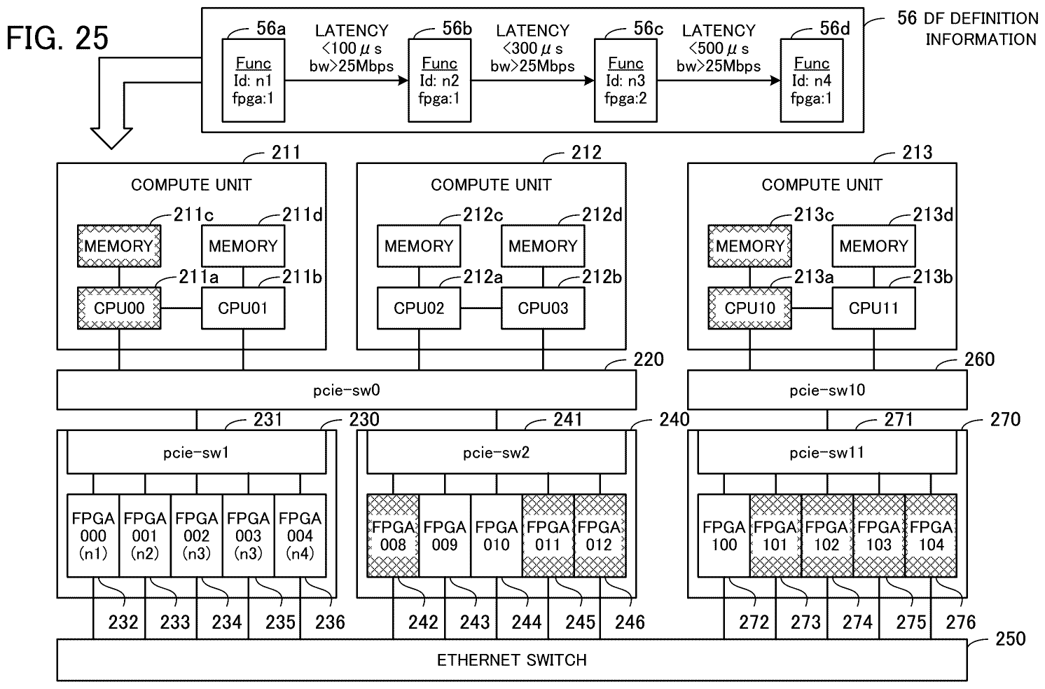

FIG. 25 illustrates an example of device selection completed at the first stage. Assume, for example, that DF definition information 56 is input to the resource deployment scheduler 110. The DF definition information 56 includes the function profiles 56a to 56d of four functions. The function profile 56a defines a function “n1.” The function profile 56b defines a function “n2.” The function profile 56c defines a function “n3.” The function profile 56d defines a function “n4.” The number of devices (FPGAs) to be allocated to each function “n1,” “n2,” and “n4” is “1.” The number of devices (FPGAs) to be allocated to the function “n3” is “2.”

The DF definition information 56 indicates that the function “n1” sends data to the function “n2.” The performance requirements for the communication path between the functions “n1” and “n2” include a latency less than “100 μs” and a bandwidth greater than “25 Mbps.” The function “n2” sends data to the function “n3.” The performance requirements for the communication path between the functions “n2” and “n3” include a latency less than “300 μs” and a bandwidth greater than “25 Mbps.” The function “n3” sends data to the function “n4.” The performance requirements for the communication path between the functions “n3” and “n4” include a latency less than “500 μs” and a bandwidth greater than “25 Mbps.”

With respect to the functions indicated in the DF definition information 56, the selection order of the functions for device allocation is as follows: the first are the functions “n1” and “n2,” the second is the function “n3,” and the third is the function “n4.”

The infrastructure system 200 includes two PCIe switches 220 and 260 that are not connected to each other.

The compute units 211 and 212 and the PCIe BOXes 230 and 240 are connected to the PCIe switch 220. The compute unit 211 includes CPUs 211a and 211b and memories 211c and 211d. The compute unit 212 includes CPUs 212a and 212b and memories 212c and 212d. The PCIe BOX 230 includes a PCIe switch 231 and FPGAs 232 to 236. The PCIe BOX 240 includes a PCIe switch 241 and FPGAs 242 to 246. The FPGAs 232 to 236 and 242 to 246 in the PCIe BOXes 230 and 240 are connected to the Ethernet switch 250.

A compute unit 213 and a PCIe BOX 270 are connected to the PCIe switch 260. The compute unit 213 includes CPUs 213a and 213b and memories 213c and 213d. The PCIe BOX 270 includes a PCIe switch 271 and FPGAs 272 to 276. The FPGAs 272 to 276 in the PCIe BOX 270 are connected to the Ethernet switch 250.

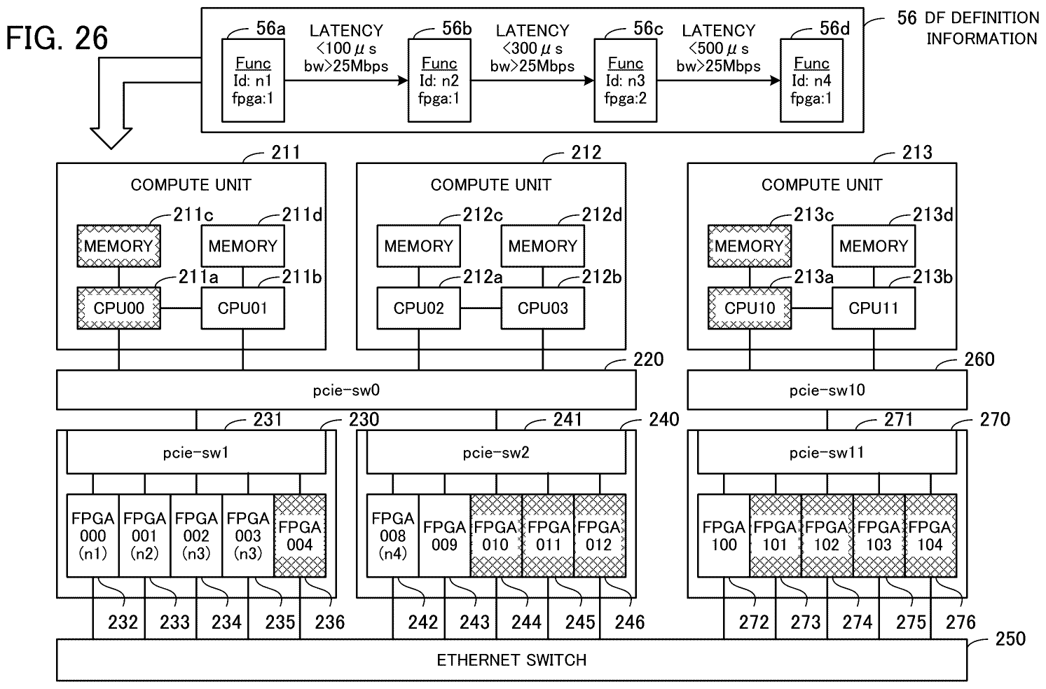

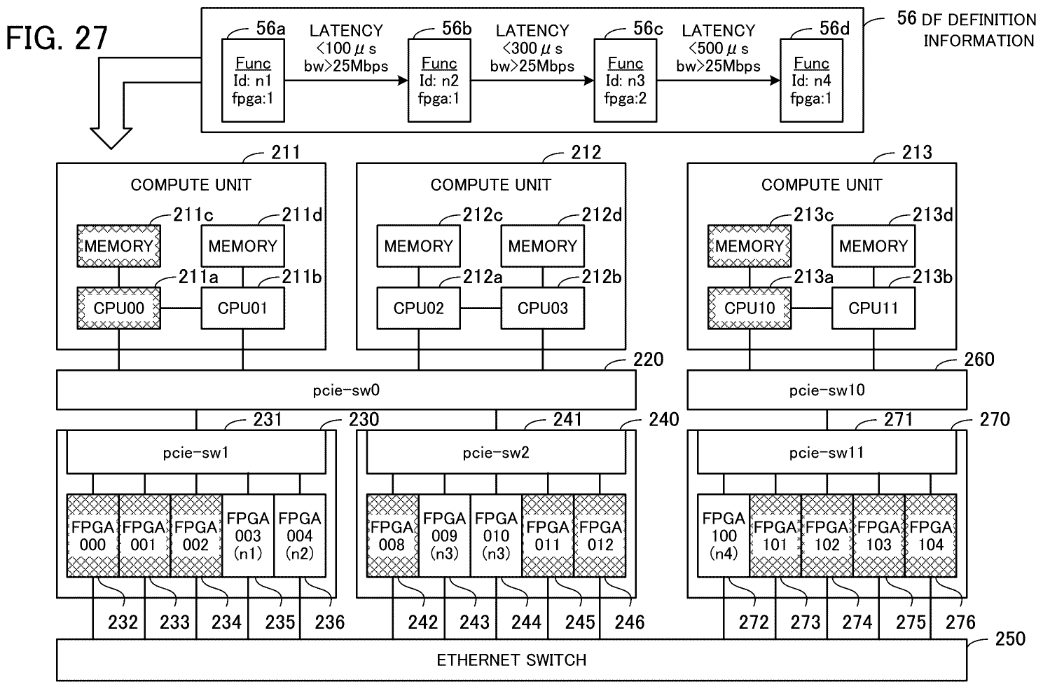

In FIG. 25, devices included in already built LSNs are hatched (the same also applies to FIGS. 26 and 27). The PCIe BOX 230 have all FPGAs 232 to 236 available. The PCIe BOX 240 has two available FPGAs 243 and 244. The PCIe BOX 270 has only one available FPGA 272.

In the example of FIG. 25, the total number of devices needed for allocation to all functions included in the DF is “5.” The PCIe BOX 230 has the five available FPGAs 232 to 236. That is, the PCIe BOX 230 has devices selectable for the allocation to all functions. For example, the FPGA 232 is allocated to the function “n1,” the FPGA 233 is allocated to the function “n2,” the FPGAs 234 and 235 are allocated to the function “n3,” and the FPGA 236 is allocated to the function “n4.” In the manner described above, the device selection is completed at the first stage.

FIG. 26 illustrates an example of device selection completed at the second stage. In the example of FIG. 26, the PCIe BOX 230 has four available FPGAs 232 to 235. The PCIe BOX 240 has two available FPGAs 242 and 243. The PCIe BOX 270 has only one available FPGA 272.

In the example of FIG. 26, there is no PCIe BOX with five or more available FPGAs. Therefore, the device selection at the first stage is not possible. Then, the device selection proceeds to the second stage. At the second stage of the device selection, the PCIe BOX 230 with the highest number of available devices is set as a starting PCIe BOX (first device selection source), and the available FPGAs 232 to 235 in the PCIe BOX 230 are allocated to functions. Then, a device to be allocated is selected from the PCIe BOX 240 that has the shortest distance via PCIe switches from the PCIe BOX 230. For example, the FPGA 232 is allocated to the function “n1,” the FPGA 233 is allocated to the function “n2,” the FPGAs 234 and 235 are allocated to the function “n3,” and the FPGA 242 is allocated to the function “n4.” In the manner described above, the device selection is completed at the second stage.

FIG. 27 illustrates an example of device selection completed at the third stage. In the example of FIG. 27, the PCIe BOX 230 has two available FPGAs 235 and 236. The PCIe BOX 240 has two available FPGAs 243 and 244. The PCIe BOX 270 has only one available FPGA 272.

In the example of FIG. 27, there is no PCIe BOX with five or more available FPGAs. Therefore, the device selection at the first stage is not possible. Then, the device selection proceeds to the second stage. At the second stage of the device selection, either the PCIe BOX 230 or 240 with the highest number of available devices is set as a starting PCIe BOX. In the example of FIG. 27, the PCIe BOX 230 is set as the starting PCIe BOX, and the available FPGAs 235 and 236 in the PCIe BOX 230 are allocated to functions. Then, devices to be allocated are selected from the PCIe BOX 240 that has the shortest distance via PCIe switches from the PCIe BOX 230.

In the example of FIG. 27, the PCIe BOXes 230 and 240 alone still do not have enough available FPGAs. Therefore, the device selection proceeds to the third stage. At the third stage of the device selection, a device is selected from the PCIe BOX 270 connected via the Ethernet switch 250. As a result, the selection of five devices to be allocated to the four functions is completed. For example, the FPGA 235 is allocated to the function “n1,” the FPGA 236 is allocated to the function “n2,” the FPGAs 243 and 244 are allocated to the function “n3,” and the FPGA 272 is allocated to the function “n4.” In the manner described above, the device selection is completed at the third stage. In the case where devices selectable for the allocation are not found at the third stage of the device selection, it is concluded that this selection is not possible, and then the selection process terminates (fourth stage).

The following describes the procedure for the device selection process in detail with reference to FIGS. 28 to 31.

FIG. 28 is a first flowchart illustrating an example procedure for the device selection process. The process of FIG. 28 will be described step by step.

Step S201: The device selection unit 113 searches for PCIe BOXes that each enable device allocation to all functions indicated in DF definition information, with reference to the device information 121b. Here, a PCIe BOX that enables device allocation to all functions is a PCIe BOX that has at least the total number of available devices needed for the allocation to all functions included in the DF.

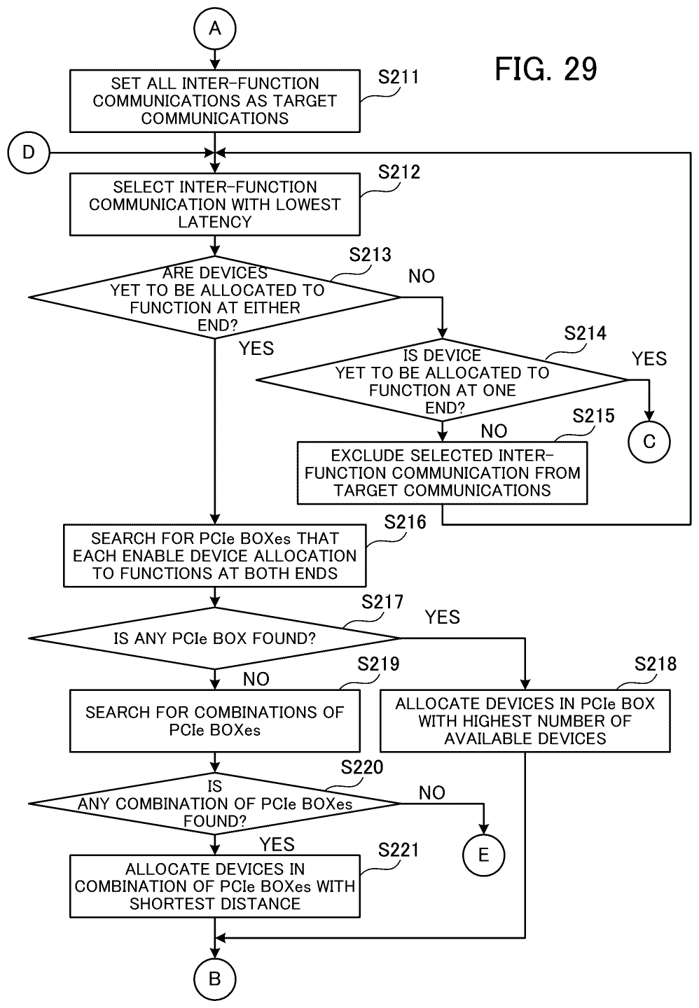

Step S202: The device selection unit 113 determines whether it has found any PCIe BOX that enables the device allocation to all functions. If such a PCIe BOX is found, the process proceeds to step S203; otherwise, the process proceeds to step S211 (see FIG. 29).

Step S203: The device selection unit 113 selects the PCIe BOX with the highest free bandwidth from the found PCIe BOXes with reference to the network status information 121c. Alternatively, the device selection unit 113 may select the PCIe BOX with the lowest bandwidth usage.

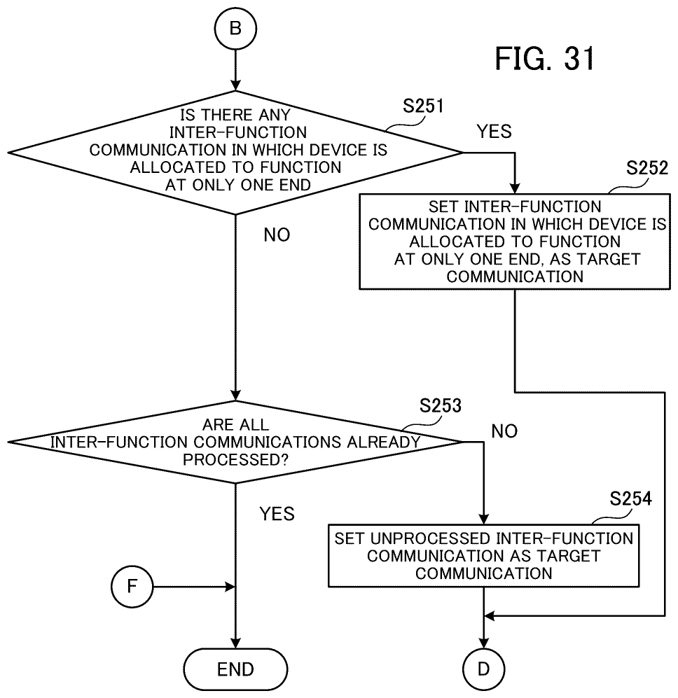

Step S204: The device selection unit 113 allocates devices in the selected PCIe BOX to all functions included in the DF. Then, the device selection unit 113 completes the device selection process (see FIG. 31).

FIG. 29 is a second flowchart illustrating the example procedure for the device selection process. The process of FIG. 29 will be described step by step.

Step S211: The device selection unit 113 sets all inter-function communications as target communications.

Step S212: The device selection unit 113 selects the inter-function communication with the lowest latency in the performance requirements from the target communications. In the case where a plurality of inter-function communications with the lowest latency are found, the device selection unit 113 selects one of them.

Step S213: The device selection unit 113 determines whether devices are yet to be allocated to the function at either end of the selected inter-function communication. If devices are yet to be allocated, meaning yes, then the process proceeds to step S216. If a device is already allocated to the function at at least one end, meaning no, then the process proceeds to step S214.

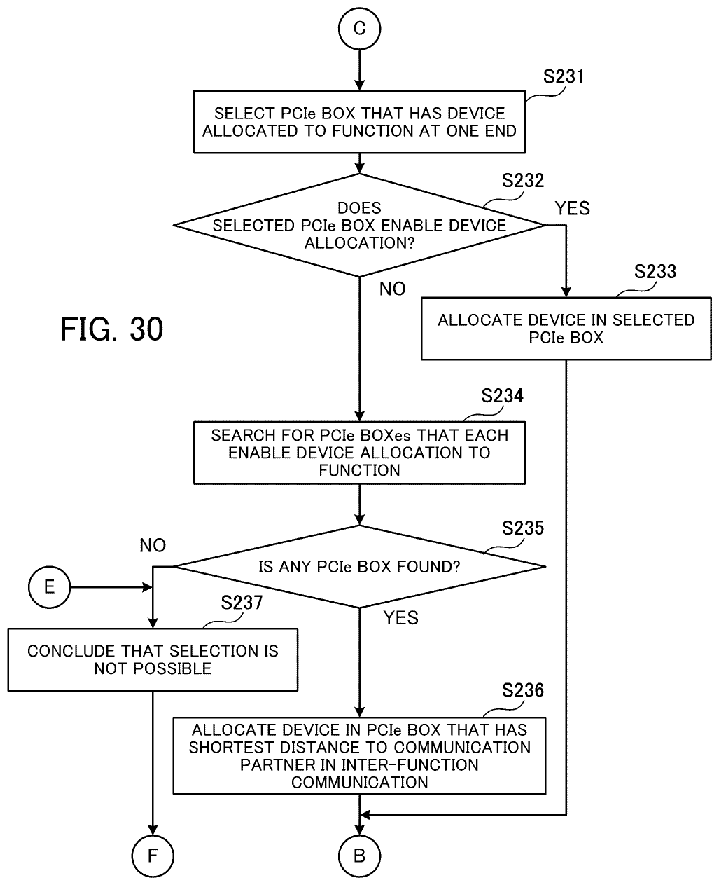

Step S214: The device selection unit 113 determines whether a device is yet to be allocated to the function at one end of the selected inter-function communication. If a device is yet to be allocated to the function at one end, meaning yes, then the process proceeds to step S231 (see FIG. 30). If devices are already allocated to the functions at both ends, meaning no, then the process proceeds to step S215.

Step S215: The device selection unit 113 excludes the selected inter-function communication from the target communications, and the process proceeds back to step S212.

Step S216: The device selection unit 113 searches for PCIe BOXes that each enable device allocation to the functions at both ends of the selected inter-function communication with reference to the device information 121b. Here, a PCIe BOX that enables device allocation to the functions at both ends is a PCIe BOX that has two or more available devices.

Step S217: The device selection unit 113 determines whether it has found any PCIe BOX that enables the device allocation to the functions at both ends of the selected inter-function communication. If such a PCIe BOX is found, the process proceeds to step S218; otherwise, the process proceeds to step S219.

Step S218: The device selection unit 113 allocates devices in the PCIe BOX with the highest number of available devices, among the found PCIe BOXes that each enable the device allocation to the functions at both ends of the selected inter-function communication, to the functions at both ends of the selected inter-function communication. Then, the process proceeds to step S251 (see FIG. 31).

Step S219: The device selection unit 113 searches for combinations of PCIe BOXes that each enable device allocation to the functions at both ends of the selected inter-function communication reference with to the device information 121b. Here, a combination of PCIe BOXes that enables device allocation to the functions at both ends is a combination of two PCIe BOXes that each have at least one available device.

Step S220: The device selection unit 113 determines whether it has found any combination of PCIe BOXes that enables the device allocation to the functions at both ends. If at least one combination of PCIe Boxes is found, the process proceeds to step S221; otherwise, the process proceeds to step S237 (see FIG. 30).

Step S221: The device selection unit 113 identifies the combination of PCIe boxes with the shortest distance from among the combinations of PCIe BOXes that each enable the device allocation to the functions at both ends of the selected inter-function communication. Then, the device selection unit 113 allocates devices respectively included in the PCIe BOXes belonging to the identified combination to the functions at both ends of the selected inter-function communication.

With regard to the communication through PCIe switches, the device selection unit 113 defines the distance of a combination of PCIe BOXes as the number of intervening PCIe switches. In addition, the device selection unit 113 determines that the communication through PCIe switches has a shorter distance than the Ethernet communication.

After that, the process proceeds to step S251 (see FIG. 31).

FIG. 30 is a third flowchart illustrating the example procedure for the device selection process. The process of FIG. 30 will be described step by step.

Step S231: The device selection unit 113 selects a PCIe BOX that has the device allocated to the function at one end of the selected inter-function communication.

Step S232: The device selection unit 113 determines whether the selected PCIe BOX enables device allocation to the function at the other end of the selected inter-function communication. If the selected PCIe BOX enables the allocation, the process proceeds to step S233; otherwise, the process proceeds to step S234.

Step S233: The device selection unit 113 allocates a device in the selected PCIe BOX to the function having no device allocated thereto in the selected inter-function communication. Then, the process proceeds to step S251 (see FIG. 31).

Step S234: The device selection unit 113 searches for PCIe BOXes that each enable device allocation to the function having no device allocated thereto in the selected inter-function communication.

Step S235: The device selection unit 113 determines whether it has found any PCIe BOX that enables the device allocation. If such a PCIe BOX is found, the process proceeds to step S236; otherwise, the process proceeds to step S237.

Step S236: The device selection unit 113 allocates a device in the PCIe BOX with the shortest distance to the communication partner in the selected inter-function communication, to the function having no device allocated thereto in the selected inter-function communication. Then, the process proceeds to step S251 (see FIG. 31).

Step S237: The device selection unit 113 terminates the device selection process with error by concluding that the selection of devices to be allocated to functions is not possible (see FIG. 31).

FIG. 31 is a fourth flowchart illustrating the example procedure for the device selection process. The process of FIG. 31 will be described step by step.

Step S251: The device selection unit 113 determines whether any inter-function communication remains in which a device is already allocated to the function at only one end. If such an inter-function communication is found, the process proceeds to step S252; otherwise, the process proceeds to step S253.

Step S252: The device selection unit 113 sets the inter-function communication in which a device is allocated to the function at only one end, as a target communication. For example, if any inter-function communication set as a target communication in the previous execution of step S252 still remains, the inter-function communication newly set as a target communication is added after the remaining inter-function communications. Then, the process proceeds to step S212 (see FIG. 29).

Step S253: The device selection unit 113 determines whether all inter-function communications indicated in the DF definition information are already processed. Here, an inter-function communication that is already processed is an inter-function communication in which devices are already allocated to the functions at both ends. If all inter-function communications are already processed, the device selection unit 113 completes the device selection process. If any unprocessed inter-function communication is found, the process proceeds to step S254.

Step S254: The device selection unit 113 sets the unprocessed inter-function communication as a target communication. Then, the process proceeds back to step S212 (see FIG. 29).

In the manner described above, devices are allocated to the functions included in the DF. The device allocation result is registered in the device allocation information 111a. When the device selection process is complete, the path selection unit 114 performs the path selection process.

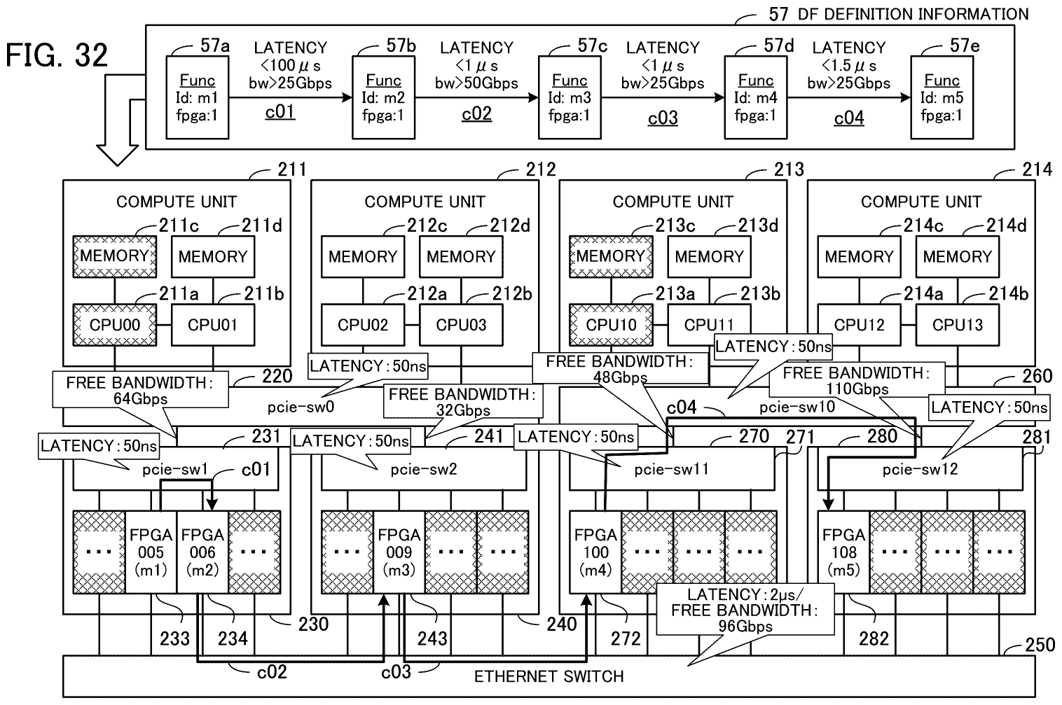

FIG. 32 illustrates an example of path selection. The path selection unit 114 selects communication paths for inter-function communications according to the following rules in order, starting with the inter-function communication with the lowest latency in the performance requirements.

Path Selection Rule 1: The path selection unit 114 selects a communication path through the Ethernet switch in the case where PCIe communication is not possible.

Path Selection Rule 2: The path selection unit 114 selects a communication path through a PCIe switch in the case where the PCIe communication is possible and the path is routed within a single PCIe BOX.

Path Selection Rule 3: The path selection unit 114 selects a communication path according to the following rules in the case where the PCIe communication is possible and the path is routed across a plurality of PCIe BOXes.

The path selection unit 114 selects a communication path through the Ethernet switch in the case where the Ethernet communication satisfies both the latency and bandwidth set in the performance requirements. The path selection unit 114 also selects the communication path through the Ethernet switch in the case where the PCIe communication does not satisfy at least one of the latency and bandwidth set in the performance requirements. On the other hand, the path selection unit 114 selects a communication path through PCIe switches in the case where the Ethernet communication does not satisfy the performance requirements but the PCIe communication satisfies the performance requirements.

In this connection, the latency of a communication path through a plurality of PCIe switches is calculated as the sum of the latencies caused in the intervening PCIe switches. The bandwidth of the communication path through the plurality of PCIe switches is the lowest free bandwidth of the paths between the intervening PCIe switches in the communication path.

FIG. 32 illustrates an example of selecting inter-function communication paths in deploying a DF indicated in DF definition information 57. The DF definition information 57 includes the function profiles 57a to 57e of five functions. The function profile 57a defines a function “m1.” The function profile 57b defines a function “m2.” The function profile 57c defines a function “m3.” The function profile 57d defines a function “m4.” The function profile 57e defines a function “m5.” The number of devices (FPGAs) to be allocated to each function “m1,” “m2,” “m3,” “m4,” and “m5” is “1.”

The DF definition information 57 indicates that the function “m1” sends data to the function “m2.” The performance requirements for the inter-function communication “c01” between the functions “m1” and “m2” include a latency less than “100 μs” and a bandwidth greater than “25 Gbps.” The function “m2” sends data to the function “m3.” The performance requirements for the inter-function communication “c02” between the functions “m2” and “m3” include a latency less than “1 μs” and a bandwidth greater than “50 Gbps.” The function “m3” sends data to the function “m4.” The performance requirements for the inter-function communication “c03” between the functions “m3” and “m4” include a latency less than “1 μs” and a bandwidth greater than “25 Gbps.” The function “m4” sends data to the function “m5.” The performance requirements for the inter-function communication “c04” between the functions “m4” and “m5” include a latency less than “1.5 μs” and a bandwidth greater than “25 Gbps.”

The infrastructure system 200 of FIG. 32 includes a compute unit 214 and a PCIe BOX 280 in addition to the configuration illustrated in FIG. 25. The compute unit 214 includes CPUs 214a and 214b and memories 214c and 214d. The PCIe BOX 280 includes a PCIe switch 281 and a plurality of FPGAS 282, . . . .

Devices are already allocated to the functions indicated in the DF definition information 57. The FPGA 233 in the PCIe BOX 230 is allocated to the function “m1.” The FPGA 234 in the PCIe BOX 230 is allocated to the function “m2.” The FPGA 243 in the PCIe BOX 240 is allocated to the function “m3.” The FPGA 272 in the PCIe BOX 270 is allocated to the function “m4.” The FPGA 282 in the PCIe BOX 280 is allocated to the function “m5.”

The PCIe switch 220 has a latency of “50 ns.” The PCIe switch 231 has a latency of “50 ns.” The PCIe switch 241 has a latency of “50 ns.” The PCIe switch 260 has a latency of “50 ns.” The PCIe switch 271 has a latency of “50 ns.” The PCIe switch 281 has a latency of “50 ns.” The free bandwidth between the PCIe switches 220 and 231 is “64 Gbps.” The free bandwidth between the PCIe switches 220 and 241 is “32 Gbps.” The free bandwidth between the PCIe switches 260 and 271 is “48 Gbps.” The free bandwidth between the PCIe switches 260 and 281 is “110 Gbps.” The Ethernet switch 250 has a latency of “2 μs” and a free bandwidth of “96 Gbps.”

The path selection in the above infrastructure system 200 is performed as follows.

The devices in the same PCIe BOX 230 are allocated to the functions “m1” and “m2.” Therefore, a communication path through the PCIe switch 231 is set for the inter-function communication “c01” between the functions “m1” and “m2.”

The devices in the different PCIe BOXes 230 and 240 are allocated to the functions “m2” and “m3.” The free bandwidth of “32 Gbps” between the PCIe switches 220 and 241 is the lowest in the PCIe communication between the PCIe BOXes 230 and 240. This free bandwidth is less than the lower limit of bandwidth of “50 Gbps” set in the performance requirements for the inter-function communication “c02” between the functions “m2” and “m3.” Therefore, a communication path through the Ethernet switch 250 is set for the inter-function communication “c02” between the functions “m2” and “m3.”

The devices in the different PCIe BOXes 240 and 270 are allocated to the functions “m3” and “m4.” There is no communication path through PCIe switches between these PCIe BOXes 240 and 270. Therefore, a communication path through the Ethernet switch 250 is set for the inter-function communication “c03” between the functions “m3” and “m4.”

The devices in the different PCIe BOXes 270 and 280 are allocated to the functions “m4” and “m5.” The free bandwidth of “48 Gbps” between the PCIe switches 260 and 271 is the lowest in the PCIe communication between the PCIe BOXes 270 and 280. This free bandwidth is greater than the lower limit of bandwidth of “25 Gbps” set in the performance requirements for the inter-function communication “c04” between the functions “m4” and “m5.” Therefore, a communication path through the PCIe switches 260, 271, and 281 is set for the inter-function communication “c04” between the functions “m4” and “m5.”

The following describes a procedure for the path selection process in detail.

FIG. 33 is a flowchart illustrating an example procedure for the path selection process. The process of FIG. 33 will be described step by step.

Step S301: The path selection unit 114 selects unprocessed inter-function communications one by one in ascending order of latency in performance requirements.

Step S302: The path selection unit 114 identifies communication paths selectable for the selected inter-function communication.

Step S303: The path selection unit 114 calculates the latency and bandwidth of each identified communication path.

Step S304: The path selection unit 114 determines whether the identified communication paths include a PCIe communication path. If a PCIe communication path is included, the process proceeds to step S305; otherwise, the process proceeds to step S309.

Step S305: The path selection unit 114 determines whether the PCIe communication path is routed within the same PCIe BOX. If the PCIe communication path is routed within the same PCIe BOX, the process proceeds to step S308; otherwise, the process proceeds to step S306.

Step S306: The path selection unit 114 determines whether the performance requirements of the selected inter-function communication are satisfied by the Ethernet communication path. If the performance requirements are satisfied, the process proceeds to step S309; otherwise, the process proceeds to step S307.

Step S307: The path selection unit 114 determines whether the performance requirements of the selected inter-function communication are satisfied by the PCIe communication. If the performance requirements are satisfied by the PCIe communication, the process proceeds to step S308; otherwise, the process proceeds to step S309.

Step S308: The path selection unit 114 selects the communication path through PCIe switches (PCIe communication) as the communication path for the selected inter-function communication. Then, the process proceeds to step S310.

Step S309: The path selection unit 114 selects the communication path through the Ethernet switch (Ethernet communication) as the communication path for the selected inter-function communication.

Step S310: The path selection unit 114 updates the bandwidth of the selected communication path. For example, the path selection unit 114 subtracts the bandwidth set in the performance requirements of the inter-function communication for which the communication path has been selected, from the free bandwidth of the selected communication path.

Step S311: The path selection unit 114 determines whether there is any unprocessed inter-function communication for which a communication path is yet to be selected. If such an unprocessed inter-function communication is found, the process proceeds back to step S301. If communication paths are selected for all inter-function communications, the path selection unit 114 completes the path selection process.

In the manner described above, a communication path is selected for each inter-function communication. When the communication path selection is complete, the server design unit 115 performs the server design process.

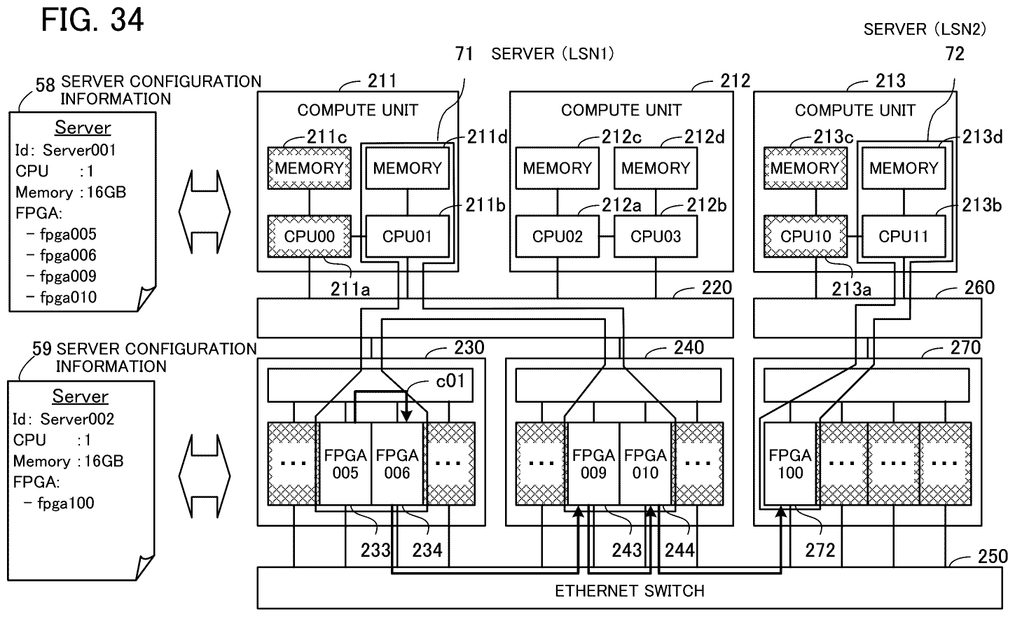

FIG. 34 illustrates an example of server design. The server design unit 115 designs the configurations of servers according to the following rules.

Server Design Rule 1: The server design unit 115 configures functions that are connectable via PCIe switches into a single server.

Server Design Rule 2: The server design unit 115 separates functions that are not connectable via PCIe switches (i.e., that are connectable only via the Ethernet switch) into different servers.

Server Design Rule 3: The server design unit 115 installs CPUs for management and memories in each server. The server design unit 115 is notified in advance of the number of CPUs to be installed and a memory capacity to be installed. In the example of FIG. 34, assume that the installation of one CPU and memory of 16 GB in each server is specified in advance.

Assume, for example, that two FPGAs 233 and 234 in the PCIe BOX 230, two FPGAs 243 and 244 in the PCIe BOX 240, and one FPGA 272 in the PCIe BOX 270 are allocated to the functions included in a DF. In this case, the PCIe BOXes 230 and 240 are connected via the PCIe switch 220. Therefore, the functions to which the FPGAs 233, 234, 243, and 244 in the PCIe BOXes 230 and 240 are allocated are configured in one server 71. The PCIe BOX 270 does not have a communication path through PCIe switches to the PCIe BOX 240 that is the communication partner in an inter-function communication. Therefore, the function to which the FPGA 272 in the PCIe BOX 270 is allocated is configured in another server 72.

The server 71 includes the CPU 211b and memory 211d. The server 72 includes the CPU 213b and memory 213d.

After designing the configurations of the servers, the server design unit 115 generates server configuration information for each server. In the example of FIG. 34, server configuration information 58 is generated for the server 71, and server configuration information 59 is generated for the server 72.

FIG. 35 is a flowchart illustrating an example procedure for the server design process. The process of FIG. 35 will be described step by step.

Step S401: The server design unit 115 selects one function for which corresponding server configuration information on a server including the device allocated to the function is yet to be generated.

Step S402: The server design unit 115 identifies the device allocated to the selected function, and a PCIe BOX containing the device.

Step S403: The server design unit 115 obtains a list of other PCIe BOXes that are connectable with the identified PCIe BOX over PCIe communication.

Step S404: The server design unit 115 identifies devices allocated to the functions included in the same DF as the selected function, from among the devices in the other PCIe BOXes listed in the obtained list.

Step S405: The server design unit 115 generates server configuration information on a server including the devices identified at steps S402 and S404, the predetermined number of CPUs, and memory of a predetermined capacity.

Step S406: The server design unit 115 determines whether there is any function for which corresponding server configuration information on a server including the device allocated to the function is yet to be generated. If such a function is found, the process proceeds back to step S401. If server configuration information on the servers including allocated devices is already generated for all functions, the server design unit 115 completes the server design process.

In the manner described above, the configurations of the servers are designed. Then, on the basis of the server configuration information indicating the determined server configurations, LSNs are built in the infrastructure system, and a server is implemented on each LSN. Then, the devices included in the implemented servers execute the corresponding functions.

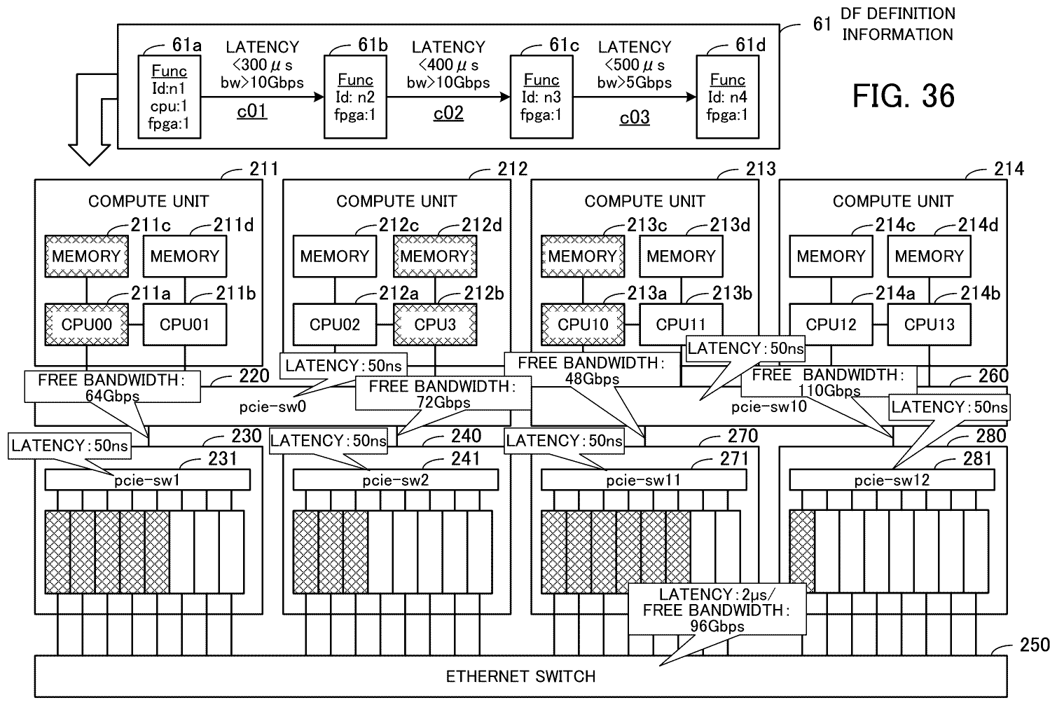

The following describes a specific example of resource deployment with reference to FIGS. 36 to 46.

FIG. 36 is a first diagram illustrating a first example of resource deployment. In the example of FIG. 36, the resource deployment process is performed on the basis of DF definition information 61. The DF definition information 61 includes the function profiles 61a to 61d of four functions. The function profile 61a defines a function “n1.” The function profile 61b defines a function “n2.” The function profile 61c defines a function “n3.” The function profile 61d defines a function “n4.” The number of devices (FPGAs) to be allocated to each function “n1,” “n2,” “n3,” and “n4” is “1.”

The DF definition information 61 indicates that the function “n1” sends data to the function “n2.” The performance requirements for the inter-function communication “c01” between the functions “n1” and “n2” include a latency less than “300 μs” and a bandwidth greater than “10 Gbps.” The function “n2” sends data to the function “n3.” The performance requirements for the inter-function communication “c02” between the functions “n2” and “n3” include a latency less than “400 μs” and a bandwidth greater than “10 Gbps.” The function “n3” sends data to the function “n4.” The performance requirements for the inter-function communication “c03” between the functions “n3” and “n4” include a latency less than “500 μs” and a bandwidth greater than “5 Gbps.”

The PCIe switch 220 has a latency of “50 ns.” The PCIe switch 231 has a latency of “50 ns.” The PCIe switch 241 has a latency of “50 ns.” The PCIe switch 260 has a latency of “50 ns.” The PCIe switch 271 has a latency of “50 ns.” The PCIe switch 281 has a latency of “50 ns.” The free bandwidth between the PCIe switches 220 and 231 is “64 Gbps.” The free bandwidth between the PCIe switches 220 and 241 is “72 Gbps.” The free bandwidth between the PCIe switches 260 and 271 is “48 Gbps.” The free bandwidth between the PCIe switches 260 and 281 is “110 Gbps.” The Ethernet switch 250 has a latency of “2 μs” and a free bandwidth of “96 Gbps.”

The PCIe BOX 230 has three available devices. The PCIe BOX 240 has five available devices. The PCIe BOX 270 has two available devices. The PCIe BOX 280 has seven available devices.

In performing resource deployment based on the DF definition information 61 in the infrastructure system 200, the device selection unit 113 first recognizes the requested number of devices (FPGA×4) needed for the DF deployment from the DF definition information 61. Then, the device selection unit 113 checks the number of available devices in each PCIe BOX against the requested number of devices, and identifies PCIe BOXes that each have at least the requested number of available devices. In the example of FIG. 36, the PCIe BOXes 240 and 280 each have at least the requested number of available devices.

Since the plurality of PCIe BOXes are found, the device selection unit 113 compares the PCIe BOXes 240 and 280 in terms of the free bandwidths of the internal PCIe switches 241 and 281 and the upper-level PCIe switches. In the example of FIG. 36, the PCIe BOX 280 has a higher free bandwidth. Therefore, the device selection unit 113 selects the PCIe BOX 280 with the highest free bandwidth as the deployment location (device selection source for allocation) of the functions. Then, the device selection unit 113 selects devices to be allocated to the functions from the seven available devices in the PCIe BOX 280.

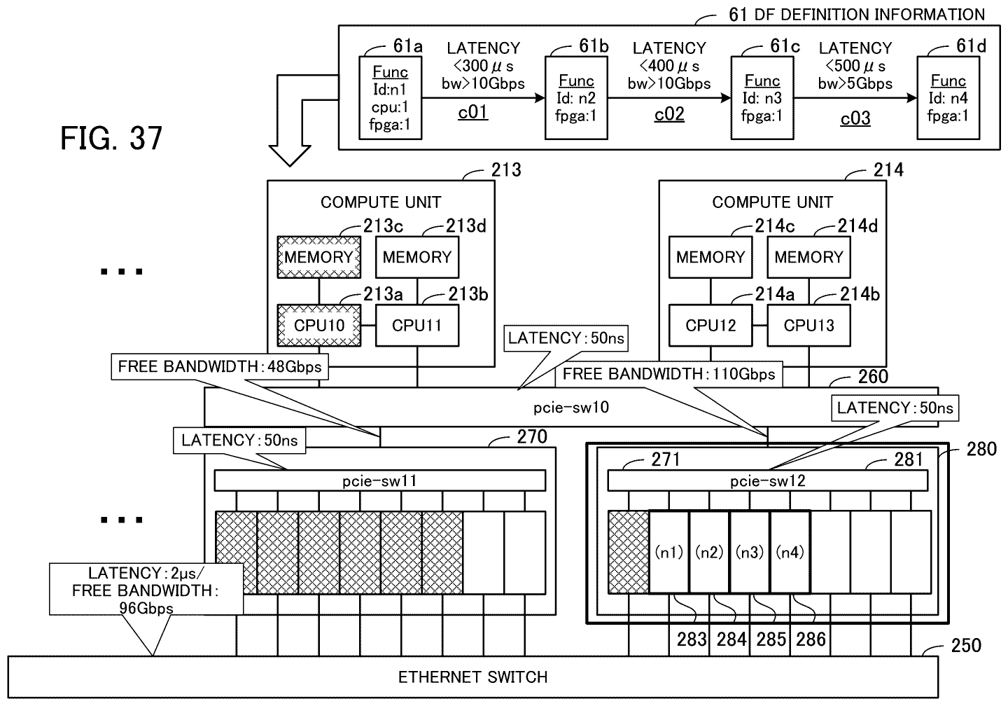

FIG. 37 is a second diagram illustrating the first example of the resource deployment. FIG. 37 illustrates a situation in which the device selection is complete for the allocation. In FIG. 37, the identifiers (n1 to n4) of the functions are indicated in the devices 283 to 286 allocated thereto in the PCIe BOX 280.

When the device selection is complete, the path selection unit 114 starts the path selection process.

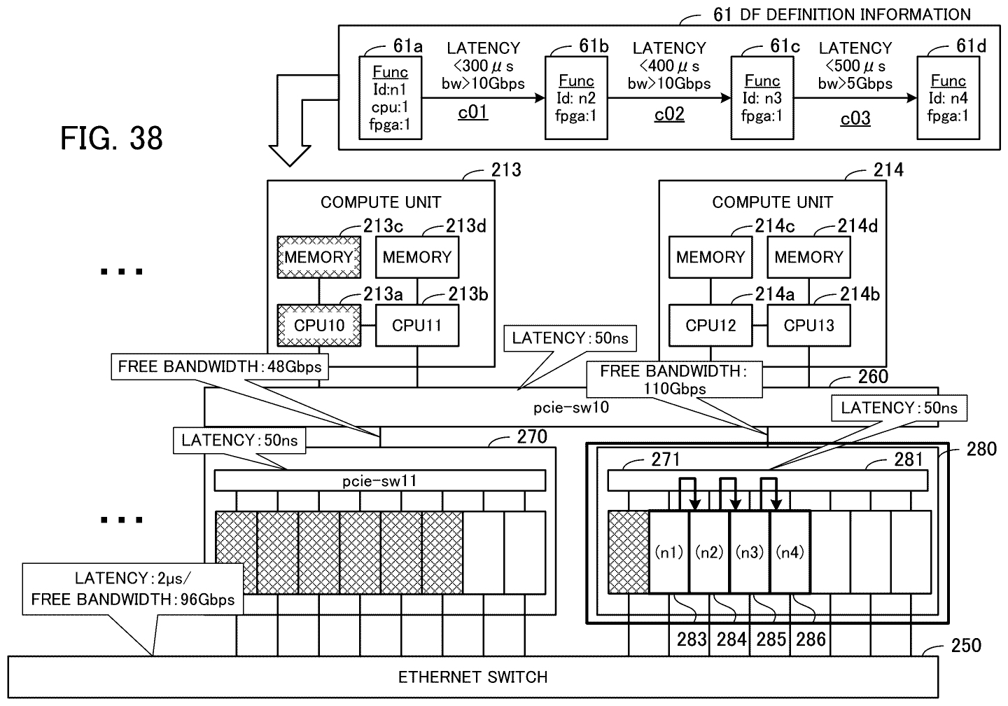

FIG. 38 is a third diagram illustrating the first example of the resource deployment. In FIG. 38, a path selected for each inter-function communication communication is indicated by a thick arrow connecting devices.

First, the path selection unit 114 selects the inter-function communication “c01” with the lowest latency in the performance requirements. Then, the path selection unit 114 identifies communication paths selectable for the selected inter-function communication “c01.” The devices 283 and 284 in the PCIe BOX 280 are allocated to the functions “n1” and “n2” at both ends of the inter-function communication “c01,” respectively. Therefore, both PCIe communication through the PCIe switch 281 and Ethernet communication through the Ethernet switch 250 are selectable as the communication path for the inter-function communication “c01.” The PCIe communication passes through only the PCIe switch 281 in the PCIe BOX 280. Therefore, the path selection unit 114 selects the PCIe communication as the communication path for the inter-function communication “c01.”

Then, the path selection unit 114 selects the inter-function communication “c02” with the next lowest latency in the performance requirements. The devices 284 and 285 in the PCIe BOX 280 are allocated to the functions at both ends of the inter-function communication “c02.” Therefore, the path selection unit 114 selects the PCIe communication as the communication path for the inter-function communication “c02.” Similarly, the path selection unit 114 selects the PCIe communication as the communication path for the inter-function communication “03.”

In the example of FIG. 38, the selected communication paths are all paths over PCIe communication within one PCIe BOX. Since this PCIe communication does not pass through a plurality of PCIe switches, there is no need to update free bandwidths in the path selection process.

When the path selection process is complete, the server design unit 115 designs server configuration.

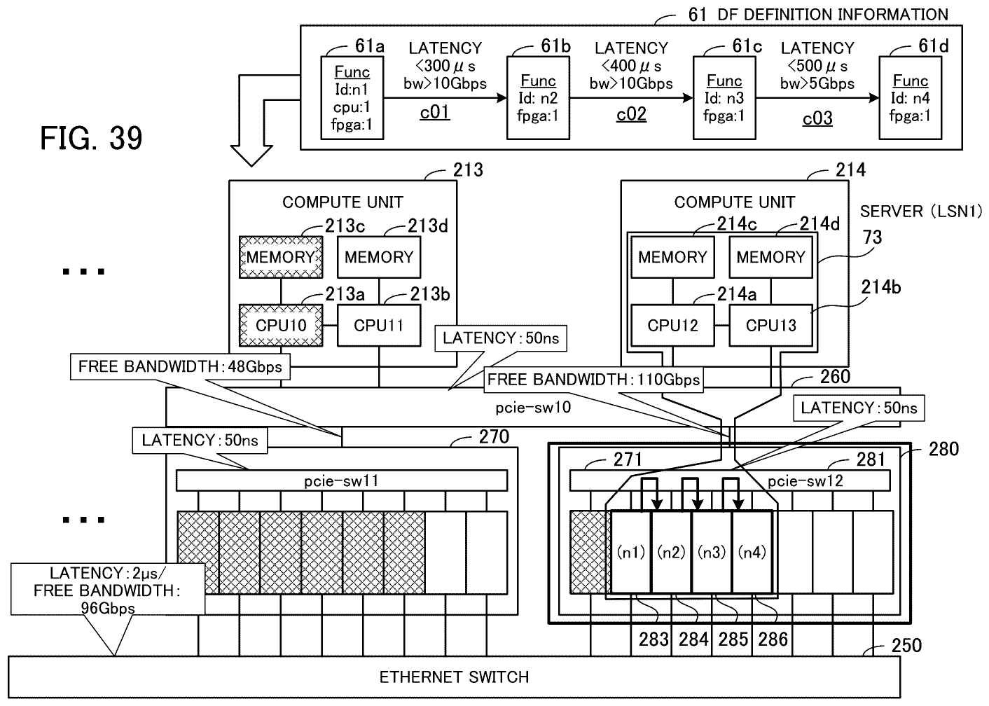

FIG. 39 is a fourth diagram illustrating the first example of the resource deployment. FIG. 39 illustrates devices included in a server 73 whose configuration is already determined.

For example, the server design unit 115 selects the function “n1,” and identifies the device 283 allocated thereto and the PCIe BOX 280 containing the device 283. Then, the server design unit 115 obtains a list of PCIe BOXes that are connectable with the identified PCIe BOX 280 via PCIe switches. The obtained list includes the PCIe BOX 270.

The server design unit 115 sets the devices 283 to 286 allocated to functions among the devices in the PCIe BOXes 270 and 280, a specified number of CPUs, a memory of a specified capacity as components of the server 73. In the example of FIG. 39, assume that the specified number of CPUs is “2” and the specified memory capacity is “520 MB.” For example, the server 73 includes the four devices 283 to 286 in the PCIe BOX 280 allocated to the functions, and two CPUs 214a and 214b and two memories 214c and 214d in the compute unit 214.

In the manner described above, the devices to be allocated to the functions as components of the server 73 are selected from the one PCIe BOX 280. Therefore, the server 73 is able to perform all inter-function communications using the PCIe communication within the PCIe BOX. As a result, the server 73 is able to execute the DF efficiently.

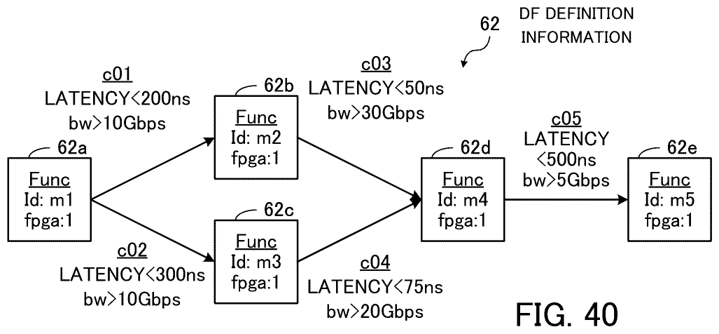

FIG. 40 is a first diagram illustrating a second example of the resource deployment. In the example of FIG. 40, the resource deployment process is performed on the basis of DF definition information 62. The DF definition information 62 includes the function profiles 62a to 62e of five functions. The function profile 62a defines a function “m1.” The function profile 62b defines a function “m2.” The function profile 62c defines a function “m3.” The function profile 62d defines a function “m4.” The function profile 62e defines a function “m5.” The number of devices (FPGAs) to be allocated to each function “m1,” “m2,” “m3,” “m4,” and “m5” is “1.”

The DF definition information 62 indicates that the function “m1” sends data to the functions “m2” and “m3.” The performance requirements for the inter-function communication “c01” between the functions “m1” and “m2” include a latency less than “200 μs” and a bandwidth greater than “10 Gbps.” The performance requirements for the inter-function communication “c02” between the functions “m1” and “m3” include a latency less than “300 μs” and a bandwidth greater than “10 Gbps.” The function “m2” sends data to the function “m4.” The performance requirements for the inter-function communication “c03” between the functions “m2” and “m4” include a latency less than “50 ns” and a bandwidth greater than “30 Gbps.” The function “m3” sends data to the function “m4.” The performance requirements for the inter-function communication “c04” between the functions and “m4” include a latency less than “75 ns” and a bandwidth greater than “20 Gbps.” The function “m4” sends data to the function “m5.” The performance requirements for the inter-function communication “c05” between the functions “m4” and “m5” include a latency less than “500 ns” and a bandwidth greater than “5 Gbps.”

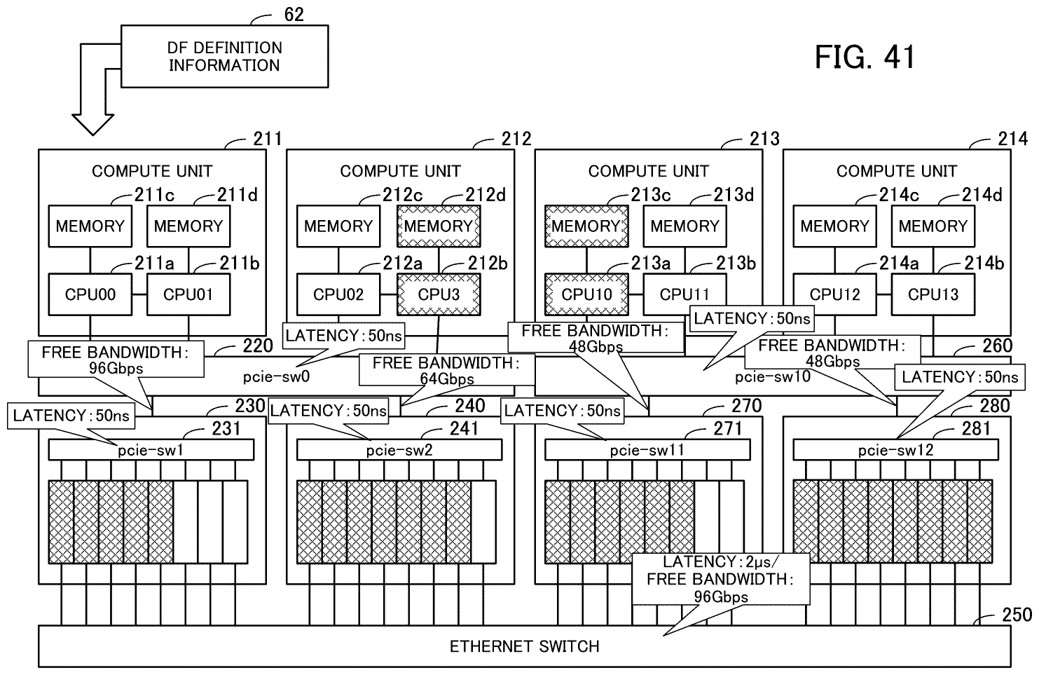

FIG. 41 is a second diagram illustrating the second example of the resource deployment. FIG. 41 illustrates the usage status of the infrastructure system 200.

The PCIe switch 220 has a latency of “50 ns.” The PCIe switch 231 has a latency of “50 ns.” The PCIe switch 241 has a latency of “50 ns.” The PCIe switch 260 has a latency of “50 ns.” The PCIe switch 271 has a latency of “50 ns.” The PCIe switch 281 has a latency of “50 ns.” The free bandwidth between the PCIe switches 220 and 231 is “96 Gbps.” The free bandwidth between the PCIe switches 220 and 241 is “64 Gbps.” The free bandwidth between the PCIe switches 260 and 271 is “48 Gbps.” The free bandwidth between the PCIe switches 260 and 281 is “48 Gbps.” The Ethernet switch 250 has a latency of “2 μs” and a free bandwidth of “96 Gbps.”

The PCIe BOX 230 has three available devices. The PCIe BOX 240 has one available device. The PCIe BOX 270 has two available devices. The PCIe BOX 280 has no available device.

In performing the resource deployment based on the DF definition information 62 in the above infrastructure system 200, the device selection unit 113 first recognizes the x) needed for the DF requested number of devices (deployment from the DF definition information 62. Then, the device selection unit 113 checks the number of available devices in each PCIe BOX against the requested number of devices, and identifies PCIe BOXes that each have at least the requested number of available devices. In the example of FIG. 41, there is no such PCIe BOX.

Therefore, the device selection unit 113 selects the inter-function communication “c03” with the lowest latency in the performance requirements from all inter-function communications. Since no devices are yet to be allocated to either function “m2” or “m4” at both ends of the inter-function communication “c03,” the device selection unit 113 searches for PCIe BOXes that each enable device allocation to the functions “m2” and “m4.” In the example of FIG. 41, the PCIe BOXes 230 and 270 are found. The device selection unit 113 selects the PCIe BOX 230 with the highest number of available devices from the PCIe BOXes 230 and 270. The device selection unit 113 allocates devices in the selected PCIe BOX 230 to the functions “m2” and “m4” at both ends of the selected inter-function communication “c03.”

Then, the device selection unit 113 focuses on other inter-function communications “c01,” “c04,” and “c05” that each have one of the functions “m2” and “m4,” just processed for the device allocation, at one end thereof. The device selection unit 113 selects the inter-function communication “c04” with the lowest latency in the performance requirements from the inter-function communications “c01,” “c04,” and “c05” in question.

A device is already allocated to the function “m4” at one end of the selected inter-function communication “c04.” Therefore, the device selection unit 113 selects the PCIe BOX 230 that contains the device allocated to this function “m4.” The device selection unit 113 determines whether the selected PCIe BOX 230 also enables device allocation to the function “m3,” having no device allocated thereto, at the other end of the selected inter-function communication “c04.” In the example of FIG. 41, the allocation is possible. Therefore, the device selection unit 113 allocates an available device in the selected PCIe BOX 230 to the function “m3.”

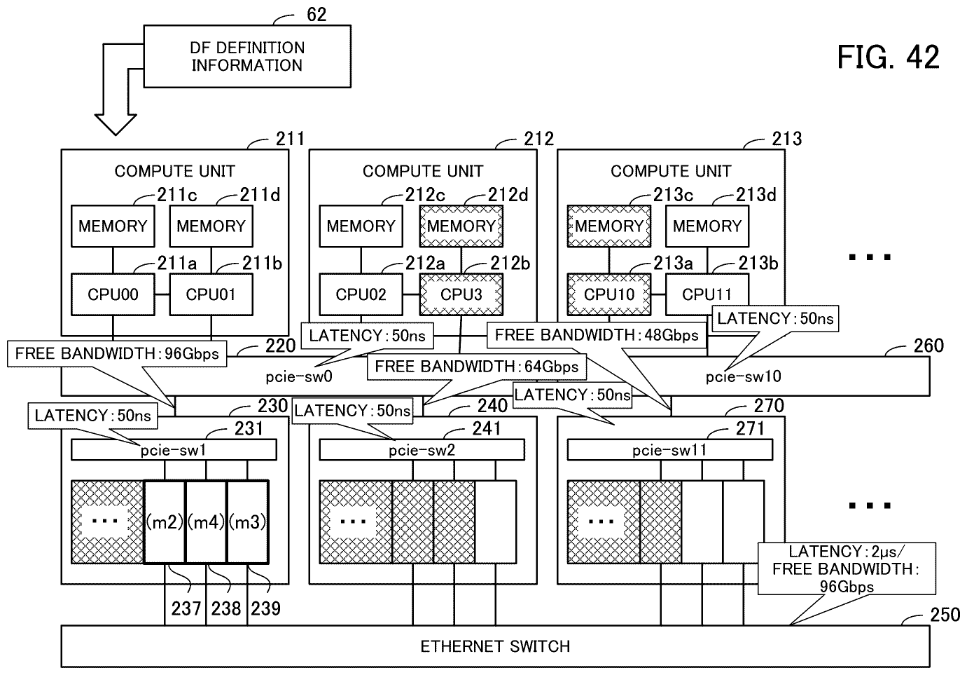

FIG. 42 is a third diagram illustrating the second example of the resource deployment. FIG. 42 illustrates a situation in which device allocation to the functions “m2,” “m3,” and “m4” is complete. The device 237 in the PCIe BOX 230 is allocated to the function “m2.” The device 239 in the PCIe BOX 230 is allocated to the function “m3.” The device 238 in the PCIe BOX 230 is allocated to the function “m4.”

The device selection unit 113 adds the inter-function communication “c02” that has the function “m3,” just processed for the device allocation, at one end thereof, as a target communication to the target communications remaining from the previous allocation (i.e., inter-function communications “c01” and “c05”). Then, the device selection unit 113 selects the inter-function communication “c01” with the lowest latency in the performance requirements from the target communications.

A device is already allocated to the function “m2” at one end of the selected inter-function communication “c01.” Therefore, the device selection unit 113 selects the PCIe BOX 230 that contains the device allocated to this function “m2.” The device selection unit 113 determines whether the selected PCIe BOX 230 also enables device allocation to the function “m1,” having no device allocated thereto, at the other end of the selected inter-function communication “c01.”

In the example of FIG. 42, such allocation is not possible. Therefore, the device selection unit 113 searches for PCIe BOXes that each enable device allocation to the function “m1.” In the example of FIG. 42, the PCIe BOXes 240 and 270 are found. The device selection unit 113 changes the selection source to the PCIe BOX 240 with the shortest distance to the selected PCIe BOX 230 among these PCIe BOXes. The device selection unit 113 then allocates an available device in the selected PCIe BOX 240 to the function “m1.”

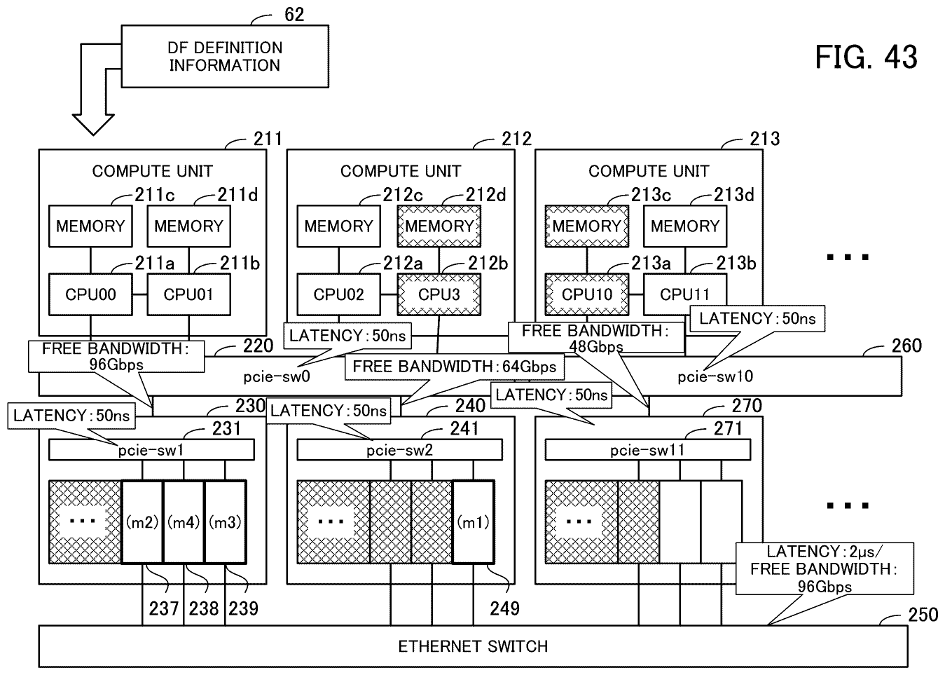

FIG. 43 is a fourth diagram illustrating the second example of the resource deployment. FIG. 43 illustrates a situation in which device allocation to the functions “m1,” “m2,” “m3,” and “m4” is complete. In this connection, the device 249 in the PCIe BOX 240 is newly allocated to the function “m1.”

The device selection unit 113 keeps the target communications remaining from the previous allocation (i.e., inter-function communications “c05” and “c02”) as target communications. From among the inter-function communications “c01” and “c02” that each have the function “m1,” just processed for the device allocation, at one end thereof, the inter-function communication “01” has, at both ends thereof, functions having devices allocated thereto, and the inter-function communication “c02” is already set as a target communication. Therefore, there is no target communication to be newly added.

The device selection unit 113 selects the inter-function communication “c02” with the lowest latency in the performance requirements from the target communications (i.e., inter-function communications “c05” and “c02”). Since the selected inter-function communication “c02” have, at both ends thereof, the functions “m1” and “m3” having devices allocated thereto, the device selection unit 113 excludes the inter-function communication “c02” from the target communications. Then, the device selection unit 113 selects the inter-function communication “c05.”

A device is already allocated to the function “m4” at one end of the selected inter-function communication “c05.” Therefore, the device selection unit 113 selects the PCIe BOX 230 that contains the device allocated to this function “m4.” The device selection unit 113 determines whether the selected PCIe BOX 230 also enables device allocation to the function “m5,” having no device allocated thereto, at the other end of the selected inter-function communication “c05.”

In the example of FIG. 43, such allocation is not possible. Therefore, the device selection unit 113 searches for PCIe BOXes that each enable device allocation to the function “m5.” In the example of FIG. 43, the PCIe BOX 270 is found. Therefore, the device selection unit 113 changes the selection source to the PCIe BOX 270. Then, the device selection unit 113 allocates an available device in the selected PCIe BOX 270 to the function “m5.”

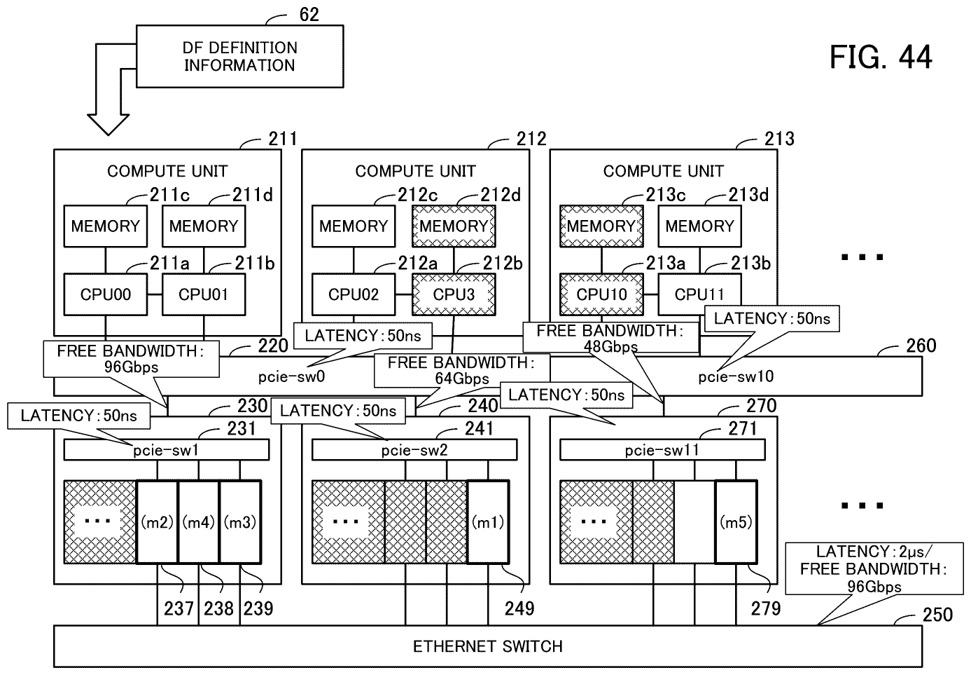

FIG. 44 is a fifth diagram illustrating the second example of the resource deployment. FIG. 44 illustrates a situation in which device allocation to all functions is complete. The device 279 in the PCIe BOX 270 is newly allocated to the function “m5.”

When the device selection is complete, the path selection unit 114 starts the path selection process.

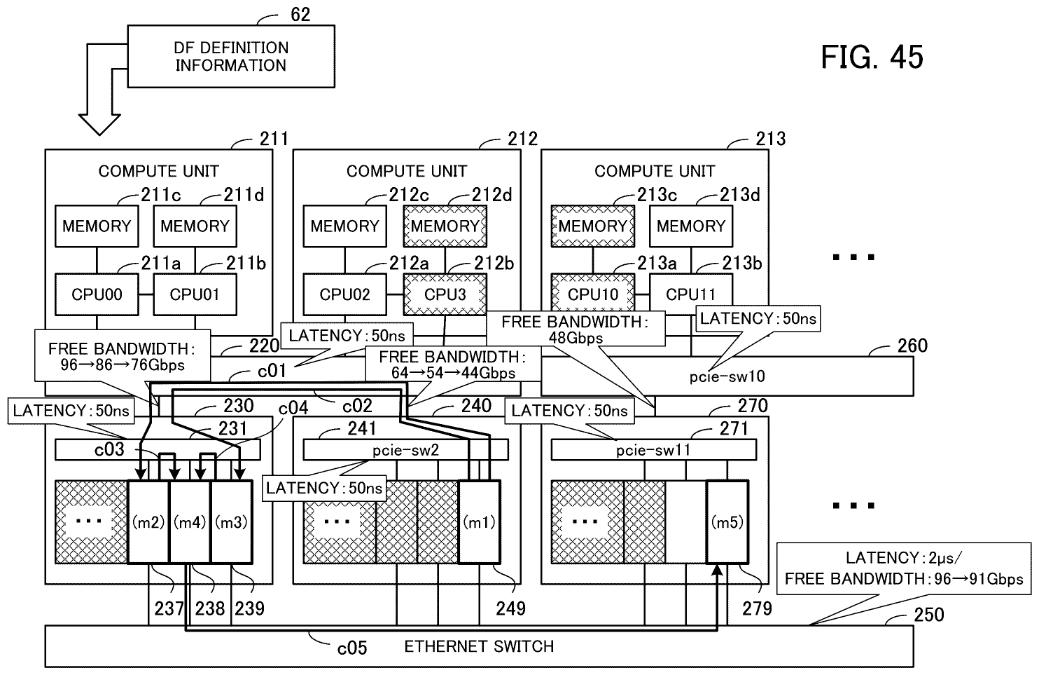

FIG. 45 is a sixth diagram illustrating the second example of the resource deployment. In FIG. 45, a communication path selected for each inter-function communication is indicated by a thick arrow connecting devices.

The path selection unit 114 selects the inter-function communication “c03” with the lowest latency in the performance requirements. Then, the path selection unit 114 identifies communication paths selectable for the selected inter-function communication “c03.” The devices 237 and 238 in the PCIe BOX 230 are allocated to the functions “m2” and “m4” at both ends of the inter-function communication “c03,” respectively. Therefore, both PCIe communication through the PCIe switch 231 and Ethernet communication through the Ethernet switch 250 are selectable as the communication path for the inter-function communication “c03.” The PCIe communication passes through only the PCIe switch 231 in the PCIe BOX 230. Therefore, the path selection unit 114 selects the PCIe communication as the communication path for the inter-function communication “c03.”

Then, the path selection unit 114 selects the inter-function communication “c04” with the next lowest latency in the performance requirements. The devices 239 and 238 in the PCIe BOX 230 are allocated to the functions “m3” and “m4” at both ends of the inter-function communication “c04,” respectively. Therefore, the path selection unit 114 selects the PCIe communication as the communication path for the inter-function communication “c04.”

After that, the path selection unit 114 selects the inter-function communication “c01” with the next lowest latency in the performance requirements. Then, the path selection unit 114 identifies communication paths selectable for the selected inter-function communication “c01.” The device 249 in the PCIe BOX 240 is allocated to the function “m1” at one end of the inter-function communication “c01,” and the device 237 in the PCIe BOX 230 is allocated to the function “m2” at the other end of the inter-function communication “c01.” In this case, the PCIe communication path passes through the PCIe switches 241, 220, and 231. The Ethernet communication path passes through the Ethernet switch 250.

The path selection unit 114 obtains the latency and free bandwidth of each identified communication path. The PCIe communication has a latency of “150 ns” and a free bandwidth of “64 Gbps.” The Ethernet communication has a latency of “2 μs” and a free bandwidth of “96 Gbps.” In this case, the Ethernet communication does not satisfy the performance requirements (a latency less than 200 ns and a bandwidth greater than 10 Gbps) of the inter-function communication “c01,” but the PCIe communication satisfies the performance requirements. Therefore, the path selection unit 114 selects the PCIe communication as the communication path for the inter-function communication “c01.”

The path selection unit 114 subtracts the value of the bandwidth set in the performance requirements of the inter-function communication “c01” from the free bandwidth of the selected communication path. This updates the free bandwidth between the PCIe switches 231 and 220 from “96 Gbps” to “86 Gbps,” and also updates the free bandwidth between the PCIe switches 241 and 220 from “64 Gbps” to “54 Gbps.”

Then, the path selection unit 114 selects the inter-function communication “c02” with the next lowest latency in the performance requirements. Then, the path selection unit 114 identifies communication paths selectable for the selected inter-function communication “c02.” The device 249 in the PCIe BOX 240 is allocated to the function “m1” at one end of the inter-function communication “c02,” and the device 239 in the PCIe BOX 230 is allocated to the function “m3” at the other end of the inter-function communication “c02.” In this case, the PCIe communication path passes through the PCIe switches 241, 220, and 231. The Ethernet communication path passes through the Ethernet switch 250.

The path selection unit 114 obtains the latency and free bandwidth of each identified communication path. The PCIe communication has a latency of “150 ns” and a free bandwidth of “54 Gbps.” The Ethernet communication has a latency of “2 μs” and a free bandwidth of “96 Gbps.” In this case, the Ethernet communication does not satisfy the performance requirements (a latency less than 300 ns and a bandwidth greater than 10 Gbps) of the inter-function communication “c02,” but the PCIe communication satisfies the performance requirements. Therefore, the path selection unit 114 selects the PCIe communication as the communication path for the inter-function communication “c02.”

The path selection unit 114 subtracts the value of the bandwidth set in the performance requirements of the inter-function communication “c02” from the free bandwidth of the selected communication path. This updates the free bandwidth between the PCIe switches 231 and 220 from “86 Gbps” to “76 Gbps,” and also updates the free bandwidth between the PCIe switches 241 and 220 from “54 Gbps” to “44 Gbps.”

Then, the path selection unit 114 selects the inter-function communication “c05” with the next lowest latency in the performance requirements. Then, the path selection unit 114 identifies communication paths selectable for the selected inter-function communication “c05.” The device 238 in the PCIe BOX 230 is allocated to the function “m4” at one end of the inter-function communication “c05,” and the device 279 in the PCIe BOX 270 is allocated to the function “m5” at the other end of the inter-function communication “c05.” In this case, no PCIe communication path exists. An Ethernet communication path passes through the Ethernet switch 250. Since only the Ethernet communication path is selectable, the path selection unit 114 selects the Ethernet communication as the communication path for the inter-function communication “c05.”

The path selection unit 114 subtracts the value of the bandwidth set in the performance requirements of the inter-function communication “c05” from the free bandwidth of the selected communication path. This updates the free bandwidth of the Ethernet switch 250 from “96 Gbps” to “91 Gbps.”

When the path selection process is complete, the server design unit 115 designs server configuration.

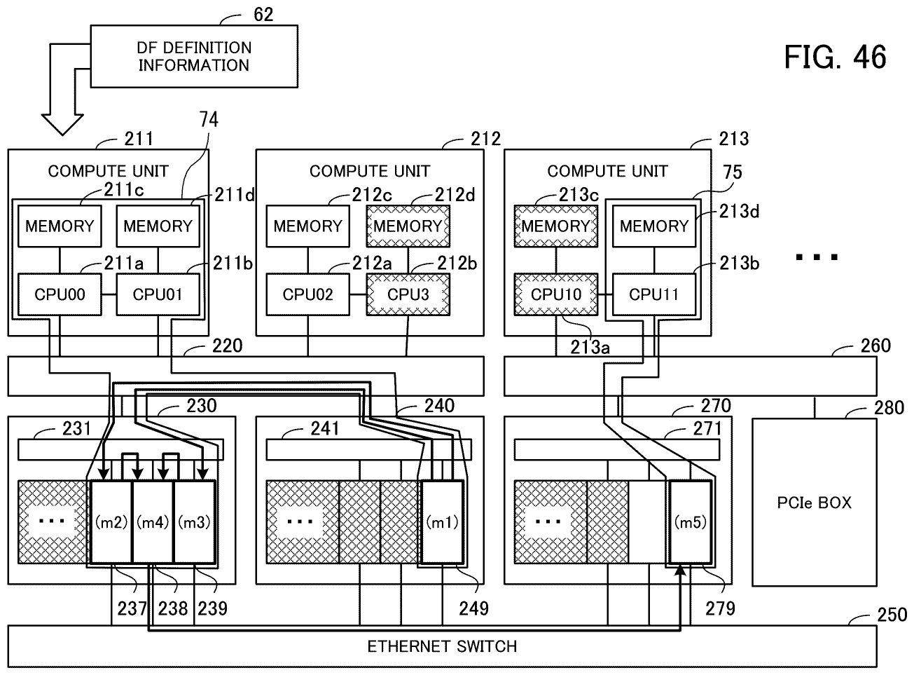

FIG. 46 is a seventh diagram illustrating the second example of the resource deployment. FIG. 46 illustrates devices included in servers 74 and 75 whose configurations are already determined.

The server design unit 115 selects, for example, the function “m1,” and identifies the device 249 allocated thereto and the PCIe BOX 240 containing the device 249. Then, the server design unit 115 obtains a list of PCIe BOXes that are connectable to the identified PCIe BOX 240 via PCIe switches. This list includes the PCIe BOX 230.

The server design unit 115 sets the devices 237 to 239 and 249 allocated to functions among the devices of the PCIe BOXes 230 and 240, a specified number of CPUs, and memory of a specified capacity as components of the server 74. In the example of FIG. 46, assume that the specified number of CPUs is “2” and the specified memory capacity is “520 MB.” For example, the server 74 includes the four devices 237 to 239 and 249 allocated to the functions in the PCIe BOXes 230 and 240, and two CPUs 211a and 211b and two memories 211c and 211d in the compute unit 211.

The server design unit 115 sets the functions to which the devices included in the server 74 are allocated, as functions for which the corresponding server configuration information is already generated. Then, the server design unit 115 selects the function “m5” for which corresponding server configuration information is yet to be generated, and identifies the device 279 and the PCIe BOX 270 containing the device 279. Then, the server design unit 115 obtains a list of PCIe BOXes that are connectable to the identified PCIe BOX 270 via PCIe switches. This list includes the PCIe BOX 280.

The server design unit 115 sets the device 279 allocated to a function among the devices in the PCIe BOXes 270 and 280, a specified number of CPUs, and memory of a specified capacity as components of the server 75. In the example of FIG. 46, assume that the specified number of CPUs is “1” and the specified memory capacity is “520 MB.” For example, the server 75 includes the one device 279 allocated to the function in the PCIe BOX 270, and the CPU 213b and the memory 213d in the compute unit 213.

The server design unit 115 sets the function to which the device included in the server 75 is allocated, as a function for which the corresponding server configuration information is already generated. Since there are no more functions for which corresponding server configuration information needs to be generated, the server design unit 115 completes the server design process.

In the manner described above, the devices to be allocated to the functions are appropriately selected and the servers 74 and 75 are configured. The servers 74 and 75 created in this manner are able to perform the processes indicated in the DF efficiently.

### Other Embodiments

In the second embodiment, the resource deployment scheduler 110, infrastructure system manager 120, and resource manager 130 are executed by the single management computer 100. Alternatively, part of their functionality may be executed by another computer. Alternatively, at least one of the resource deployment scheduler 110, infrastructure system manager 120, and resource manager 130 may be executed by an LSN built in the infrastructure system 200.

The second embodiment uses, by way of example, FPGAS as devices and allocating the FPGAs to functions. Alternatively, modules containing CPUs and GPUs may be used as such devices.

According to one aspect, it is possible to facilitate a series of processes that are performed using a plurality of functions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A resource allocation apparatus comprising:
a memory; and
a processor coupled to the memory and the processor configured to:
first select, based on process information indicating a plurality of functions to be used in performing a process and performance requirements for communications between the plurality of functions, the plurality of functions one by one as a first function in order of the performance requirements, the process being performed by a computing system including a plurality of devices, each of the plurality of devices being bus-connected to one or more others of the plurality of devices; and
determine a first device that is used to implement the first function, based on distances of bus-based communication paths between each of devices that are able to implement the first function and a second device that is used to implement a second function that is a communication partner of the first function.

2. The resource allocation apparatus according to claim 1, wherein the first select includes selecting the plurality of functions in order, starting with a function that needs a communication with a lowest allowable latency.

3. The resource allocation apparatus according to claim 1, wherein the determine includes setting, as the first device, a device that has fewest switches in a bus-based communication path to the second device.

4. The resource allocation apparatus according to claim 1, wherein the determine includes setting, as the first device, a device that is network-connected to the second device upon determining that the devices that are able to implement the first function do not include any device that is bus-connected to the second device.

5. The resource allocation apparatus according to claim 1, wherein the processor is further configured to:
second select, each combination for of two communicating functions that perform a communication with each other among the plurality of functions, either one of a first communication path via bus or a second communication path via network as a communication path for the communication, based on performance requirements for the communication, and a number of switches in a bus-based communication path connecting devices that respectively implement the two communicating functions or performance of bus-based communication and network-based communication.

6. The resource allocation apparatus according to claim 5, wherein the second select includes selecting the first communication path as the communication path for the communication upon determining that the bus-based communication path passes through only one switch.

7. The resource allocation apparatus according to claim 5, wherein the second select includes selecting the second communication path as the communication path for the communication upon determining that both the bus-based communication and the network-based communication satisfy the performance requirements for the communication.

8. The resource allocation apparatus according to claim 5, wherein the second select includes selecting the second communication path as the communication path for the communication upon determining that neither the bus-based communication nor the network-based communication satisfies the performance requirements for the communication.

9. A resource allocation method comprising:
selecting, by a processor, based on process information indicating a plurality of functions to be used in performing a process and performance requirements for communications between the plurality of functions, the plurality of functions one by one as a first function in order of the performance requirements, the process being performed by a computing system including a plurality of devices, each of the plurality of devices being bus-connected to one or more others of the plurality of devices; and
determining, by the processor, a first device that is used to implement the first function, based on distances of bus-based communication paths between each of devices that are able to implement the first function and a second device that is used to implement a second function that is a communication partner of the first function.

10. A non-transitory computer-readable storage medium storing a computer program that causes a computer to perform a process comprising:
selecting, based on process information indicating a plurality of functions to be used in performing a process and performance requirements for communications between the plurality of functions, the plurality of functions one by one as a first function in order of the performance requirements, the process being performed by a computing system including a plurality of devices, each of the plurality of devices being bus-connected to one or more others of the plurality of devices; and
determining a first device that is used to implement the first function, based on distances of bus-based communication paths between each of devices that are able to implement the first function and a second device that is used to implement a second function that is a communication partner of the first function.
